(19) United States
(12) Patent Application Publication
(10) Pub. No.: US 2025/0089116 A1
(43) Pub. Date: Mar. 13, 2025

(54) METHOD, BASE STATION, ELECTRONIC APPARATUS AND STORAGE MEDIUM FOR SUPPORTING MULTICAST TRANSMISSION

(71) Applicant: Samsung Electronics Co., Ltd., Suwon-si, Gyeonggi-do (KR)

(72) Inventors: Hong WANG, Beijing (CN); Lixiang XU, Beijing (CN); Weiwei WANG, Beijing (CN)

(21) Appl. No.: 18/727,558

(22) PCT Filed: Jan. 27, 2023
(86) PCT No.: PCT/KR2023/001300

§ 371 Date: Jul. 9, 2024

(30) Foreign Application Priority Data
Jan. 29, 2022 (CN) 202210113119.4
Aug. 16, 2022 (CN) 202210983556.1

(51) Int. Cl. H04W 76/19; H04W 4/06; H04W 76/20; H04W 76/30

(52) U.S. Cl. CPC H04W 76/19; H04W 4/06; H04W 76/20; H04W 76/30

(57) ABSTRACT

The disclosure relates to a 5G or 6G communication system for supporting a higher data transmission rate. The present disclosure relates to a method, a base station, an electronic apparatus and a storage medium for supporting multicast transmission. A method performed by a Centralized Unit (CU) of a second base station comprising the CU and at least one Distributed Unit (DU), the method comprising: receiving a Radio Resource Control (RRC) resume request message comprising a RRC resume reason from a User Equipment (UE), the RRC resume reason being set for a purpose of transmission of a MBS; as a response to the RRC resume request message, sending configuration information of a Multimedia Broadcast Multicast Service (MBS) Radio Bearer (MRB) and/or suspension indication information to the UE.

### CROSS-REFERENCE TO RELATED APPLICATION(S)

This application is a U.S. National Stage application under 35 U.S.C. § 371 of an International application number PCT/KR2023/001300, filed on Jan. 27, 2023, which is based on and claims priority of a Chinese patent application number 202210113119.4, filed on Jan. 29, 2022, in the Chinese National Intellectual Property Administration, and of a Chinese patent application number 202210983556.1, filed on Aug. 16, 2022, in the Chinese National Intellectual Property Administration, the disclosure of each of which is incorporated by reference herein in its entirety.

### TECHNICAL FIELD

The present disclosure relates to a communication field, and especially relates to a method, a base station, an electronic device and a storage medium for supporting multicast transmission.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE

### Technical Problem

The present disclosure provides a method, a base station, an electronic apparatus, and a storage medium for supporting multicast transmission to at least solve the above problems in related technologies.

### Technical Solution

According to a first aspect of an embodiment of the present disclosure, a method executed by a Centralized Unit (CU) of a second base station including the CU and at least one Distributed Unit (DU) is provided, the method including: receiving a Radio Resource Control (RRC) resume request message including a RRC resume reason from a User Equipment (UE), the RRC resume reason is set for a purpose of transmission of a Multimedia Broadcast Multicast Service (MBS); as a response to the RRC resume request message, sending configuration information of a MBS Radio Bearer (MRB) and/or suspension indication information to the UE, wherein the configuration information of the MRB is used to enable the UE to receive the MBS service, and wherein the suspension indication information is used to enable the UE to enter a RRC inactive status.

Alternatively, the sending the configuration information of the MRB and/or the suspension indication information to the UE includes: sending a UE context establishment request message to the DU of the second base station, wherein the configuration information of the MRB and/or the suspension indication information are included in a RRC container in the UE context establishment request message; sending the configuration information of the MRB and/or the suspension indication information to the UE via the DU of the second base station.

Alternatively, the configuration information of the MRB and/or the suspension indication information are included in a RRC resume message or a RRC reconfiguration request message in the RRC container.

Alternatively, the sending the configuration information of the MRB and/or the suspension indication information to the UE via the DU of the second base station includes: sending the configuration information of the MRB and/or the suspension indication information to the UE through the RRC resume message or the RRC reconfiguration request message via the DU of the second base station.

Alternatively, the UE context establishment request message further includes identification information of the MBS, Quality of Service (QOS) information of the MBS and an uplink transmission layer address for the MBS.

Alternatively, the sending the configuration information of the MRB and/or the suspension indication information to the UE includes: sending a RRC message transmission including a RRC resume message or a RRC reconfiguration request message to the DU of the second base station, wherein the configuration information of the MRB and/or the suspension indication information are included in the RRC resume message or the RRC reconfiguration request message; sending the configuration information of the MRB and/or the suspension indication information to the UE through the RRC resume message or the RRC reconfiguration request message via the DU of the second base station.

Alternatively, the sending the configuration information of the MRB and/or the suspension indication information to the UE includes sending a RRC connection release request message to the UE, wherein the configuration information of the MRB and/or the suspension indication information are included in the RRC connection release request message.

Alternatively, the method further includes: receiving a Radio Access Network (RAN) paging message including identification information of the MBS from a CU of a first base station; and sending the RAN paging message to the DU of the second base station.

Alternatively, the RAN paging message further includes information for indicating that a paging reason is the MBS.

Alternatively, the RAN paging message is a RAN paging message for a single UE or a RAN group paging message for a plurality of UEs.

Alternatively, the method further includes: sending an retrieve UE context request message including indication information of the MBS to the CU of the first base station, wherein the indication information is used to indicate that a sending reason of UE context information is the MBS; receiving an retrieve UE context response message including context information of the UE from the CU of the first base station.

Alternatively, the retrieve UE context request message further includes identification information of the MBS.

Alternatively, the retrieve UE context response message further includes a corresponding relation between a unicast QoS flow and a multicast QoS flow, the identification information of the MBS, and QoS information of the MBS.

Alternatively, the retrieve UE context response message further includes indication information for indicating whether the MBS is in an active status.

According to a second aspect of an embodiment of the present disclosure, a method performed by a Distributed Unit (DU) of a second base station including a Centralized Unit (CU) and at least one DU is provided, the method including: receiving a Radio Resource Control (RRC) resume request message including a RRC resume reason from a user equipment (UE), the RRC resume reason is set for a purpose of transmission of a Multimedia Broadcast Multicast Service (MBS); and as a response to the RRC resume request message, sending configuration information of a MBS Radio Bearer (MRB) and/or suspension indication information to the UE, wherein the configuration information of the MRB is used to enable the UE to receive the MBS service, and wherein the suspension indication information is used to enable the UE to enter a RRC inactive status.

Alternatively, the method further includes receiving the configuration information of the MRB and/or the suspension indication information from the CU of the second base station.

Alternatively, the receiving the configuration information of the MRB and/or the suspension indication information from the CU of the second base station includes: receiving a UE context establishment request message from the CU of the second base station, wherein the configuration information of the MRB and/or the suspension indication information are included in a RRC container in the UE context establishment request message.

Alternatively, the configuration information of the MRB and/or the suspension indication information are included in a RRC resume message or a RRC reconfiguration request message in the RRC container.

Alternatively, the UE context establishment request message further includes identification information of the MBS, Quality of Service (QOS) information of the MBS, and an uplink transmission layer address for the MBS.

Alternatively, the receiving the configuration information of the MRB and/or the suspension indication information from the CU of the second base station includes: receiving a RRC message transmission including a RRC resume message or a RRC reconfiguration request message from the CU of the second base station, wherein the configuration information of the MRB and/or the suspension indication information are included in the RRC resume message or the RRC reconfiguration request message.

Alternatively, the sending the configuration information of the MRB and/or the suspension indication information to the UE includes: sending the configuration information of the MRB and/or the suspension indication information to the UE through the RRC resume message or the RRC reconfiguration request message.

Alternatively, the sending the configuration information of the MRB and/or the suspension indication information to the UE includes: sending, to the UE, a RRC connection release request message received form the CU of the second base station, wherein the configuration information of the MRB and/or the suspension indication information are included in the RRC connection release request message.

Alternatively, the method further includes: receiving a RAN paging message including identification information of the MBS from the CU of the second base station; and sending the RAN paging message to the UE.

Alternatively, the RAN paging message further includes information for indicating that a paging reason is the MBS.

Alternatively, the RAN paging message is a RAN paging message for a single UE or a RAN group paging message for a plurality of UEs.

According to a third aspect of an embodiment of the present disclosure, a Centralized Unit (CU) of a base station including the CU and at least one Distributed Unit (DU) is provided, the CU including: a transceiver; and a processor coupled to the transceiver and configured to perform the method performed by the CU as described above.

According to the fourth aspect of an embodiment of the present disclosure, a Distributed Unit (DU) of a base station including a Centralized Unit (CU) and at least one DU is provided, and the DU includes: a transceiver; and a processor coupled to the transceiver and configured to perform the method performed by the DU as described above.

According to the fifth aspect of an embodiment of the present disclosure, a method performed by a User Equipment (UE) in a communication system is provided, which including: sending, a Radio Resource Control (RRC) resume request message including a RRC resume reason to a Distributed Unit (DU) of a second base station, wherein the RRC resume reason is set for a purpose of transmission of a Multimedia Broadcast Multicast Service (MBS); receiving configuration information of a MBS Radio Bearer (MRB) and/or suspension indication information from the DU of the second base station, wherein the configuration information of the MRB is used to enable the UE to receive the MBS service, and wherein the suspension indication information is used to enable the UE to enter a RRC inactive status.

Alternatively, the receiving the configuration information of the MRB and/or the suspension indication information from the DU of the second base station includes: receiving a RRC resume message or a RRC reconfiguration request message from the DU of the second base station, wherein the configuration information of the MRB and/or the suspension indication information are included in the RRC resume message or the RRC reconfiguration request message.

Alternatively, the receiving the configuration information of the MRB and/or the suspension indication information from the DU of the second base station includes: receiving a RRC connection release request message from the DU of the second base station, wherein the configuration information of the MRB and/or the suspension indication information are included in the RRC connection release request message.

Alternatively, the method further includes: receiving a RAN paging message including identification information of the MBS from the DU of a second base station.

Alternatively, the RAN paging message further includes information for indicating that a paging reason is the MBS.

Alternatively, the RAN paging message is a RAN paging message for a single UE or a RAN group paging message for a plurality of UEs.

According to another aspect of an embodiment of the present disclosure, there is provided with a method for mobility performed by a first network apparatus, the method includes: receiving a first message for requesting a handover from a second network apparatus, wherein the message carries first sequence number information; and sending a second message to the second network apparatus.

Alternatively, the first sequence number information includes a hyper frame number and a packet data convergence protocol sequence number.

Alternatively, the first sequence number information includes partial bits of the hyper frame number and partial bits of the packet data convergence protocol sequence number.

Alternatively, the second message sent to the second network apparatus carries a radio resource connection control message to be sent to the user.

Alternatively, the radio resource connection control message includes partial bits of the hyper frame number and partial bits of the packet data convergence protocol sequence number.

Alternatively, the first sequence number information includes a packet data convergence protocol sequence number.

Alternatively, the first network apparatus includes a control plane entity and a user plane entity, and the method further includes: receiving, by the control plane entity, a data forwarding stop required message from the user plane entity; and forwarding, by the first network apparatus, the data forwarding stop required message received from the user plane entity to the second network apparatus.

According to another aspect of an embodiment of the present disclosure, there is provided with a method for mobility performed by a second network apparatus, the method includes: sending a first message for requesting a handover to a first network apparatus, wherein the message carries first sequence number information; and receiving a second message from the first network apparatus.

According to a sixth aspect of an embodiment of the present disclosure, a user equipment is provided, which including: a transceiver; and a processor coupled to the transceiver and configured to perform the method performed by the UE in the communication system as described above.

According to a seventh aspect of an embodiment of the present disclosure, an electronic apparatus is provided, which including: at least one processor; and at least one memory storing computer-executable instructions, wherein the computer-executable instructions, when being executed by the at least one processor, cause the at least one processor to perform any of the methods described above.

According to an eighth aspect of an embodiment of the present disclosure, a computer-readable storage medium storing instructions is provided, the instructions, when being executed by at least one processor, cause the at least one processor to perform the method described above.

According to another aspect of an embodiment of the present disclosure, an electronic device is provided, which includes: a transceiver; and a controller coupled to the transceiver and configured to perform the method as described above.

It should be understood that the above general description and the detailed description later are only exemplary and explanatory, and do not limit the present

### DISCLOSURE

### Advantageous Effects

The technical solutions provided by the embodiments of the present disclosure at least bring the following advantageous effects: it may reduce additional signaling overhead of multicast data transmission, increase access efficiency of access network resources and/or air interface resources, reduce transmission delay, and enable the UE to receive data of multicast services in an energy-saving manner.

### DESCRIPTION OF DRAWINGS

The accompanying drawings herein are incorporated into the description and constitute a part of the specification, illustrate example embodiments consistent with the present disclosure, and are used together with the specification to explain principles of the present disclosure, and do not constitute an improper limitation of the present disclosure.

FIG. 1 is an exemplary system architecture of a System Architecture Evolution (SAE).

FIG. 2 is an exemplary system architecture according to various embodiments of the present disclosure.

FIGS. 3A and 3B are a first example showing a method for supporting multicast transmission according to an exemplary embodiment of the present disclosure.

FIGS. 4A and 4B are a schematic diagram showing a second example of a method for supporting multicast transmission according to an exemplary embodiment of the present disclosure;

FIG. 5 is a flowchart showing a method, performed by a CU of a second base station, for supporting multicast transmission according to an exemplary embodiment of the present disclosure;

FIG. 6 is a schematic diagram showing a third example of a method for supporting multicast transmission according to an exemplary embodiment of the present disclosure;

FIG. 7 is a schematic diagram showing a fourth example of a method for supporting multicast transmission according to an exemplary embodiment of the present disclosure;

FIG. 8 is a schematic diagram showing a fifth example of a method for supporting multicast transmission according to an exemplary embodiment of the present disclosure;

FIG. 9 is a schematic diagram showing a sixth example of a method for supporting multicast transmission according to an exemplary embodiment of the present disclosure;

FIG. 10 is a flowchart showing a method, performed by a DU of a second base station, for supporting multicast transmission according to an exemplary embodiment of the present disclosure;

FIG. 11 is a block diagram showing a CU of a second base station according to an exemplary embodiment of the present disclosure.

FIG. 12 is a block diagram showing a DU of a second base station according to an exemplary embodiment of the present disclosure.

FIG. 13 is a schematic diagram showing a sixth embodiment of a method for supporting multicast transmission according to an exemplary embodiment of the present disclosure.

### MODE FOR INVENTION

In order to enable ordinary people in the art to better understand technical solutions of the present disclosure, the technical solutions in the embodiments of the present disclosure will be clearly and completely described below in combination with the drawings.

It should be noted that the terms “first” and “second” in the specification and claims of the present disclosure and the above drawings are used to distinguish similar objects, and not necessarily used to describe a specific order or sequence. It should be understood that data used in this way may be interchanged under appropriate circumstances so that the embodiments of the present disclosure described herein may be implemented in an order other than those illustrated or described herein. The implementations described in the following embodiments do not represent all implementations consistent with the present disclosure. On the contrary, they are merely examples of devices and methods consistent with some aspects of the present disclosure as detailed in the appended claims.

It should be noted here that “at least one of several items” appearing in the present disclosure all means including the three parallel cases: “any one of the several items”, “a combination of any multiple of the several items”, and “the entirety of the several items”. For example, “including at least one of A and B”, that is, includes the following three parallel cases: (1) including A; (2) including B; and (3) including A and B. For another example, “executing at least one of Step 1 and Step 2”, that is, indicates the following three parallel cases: (1) executing Step 1; (2) executing Step 2; and (3) executing Step 1 and Step 2.

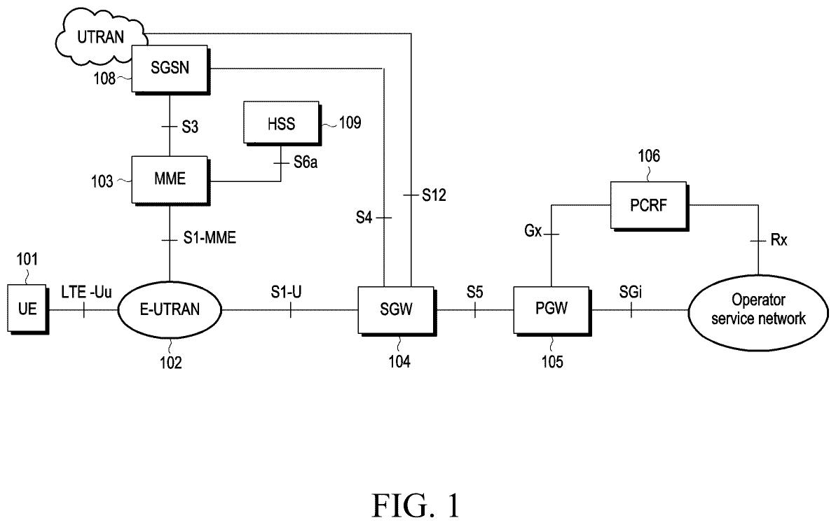

FIGS. 1 to 12 discussed below and various embodiments for describing principles of the present disclosure in the present patent document are for illustration only, and should not be interpreted in any way as limiting the scope of the present disclosure. Those skilled in the art will understand that the principles of the present disclosure may be implemented in any appropriately arranged system or apparatus.

FIG. 1 is an exemplary system architecture 100 of a System Architecture Evolution (SAE). The User Equipment (UE) 101 is a terminal apparatus for receiving data. The Evolved UMTS Terrestrial Radio Access Network (E-UTRAN) 102 is a wireless access network, which includes a Macro Site (eNodeB/NodeB) that provides an access wireless network interface for the UE. The Mobility Management Entity (MME) 103 is in charge of managing mobile context, session context and security information of the UE. A Serving GateWay (SGW) 104 mainly provides functions of a user plane, and MME 103 and SGW 104 may be in the same physical entity. A PDN Gate Way (PGW) 105 is in charge of functions such as charging, lawful interception and so on, and may also be in the same physical entity as the SGW 104. A Policy and Charging Rules Function (PCRF) 106 provides quality of service (QOS) policies and charging criteria. A Serving GPRS Support Node (SGSN) 108 is a network node apparatus that provides a route for transmission of data in a Universal Mobile Telecommunications System (UMTS). A Home Subscriber Server (HSS) 109 is a home subsystem of the UE, which is in charge of protecting user information including a current location of the UE, an address of the service node, user security information, packet data context of the UE and so on.

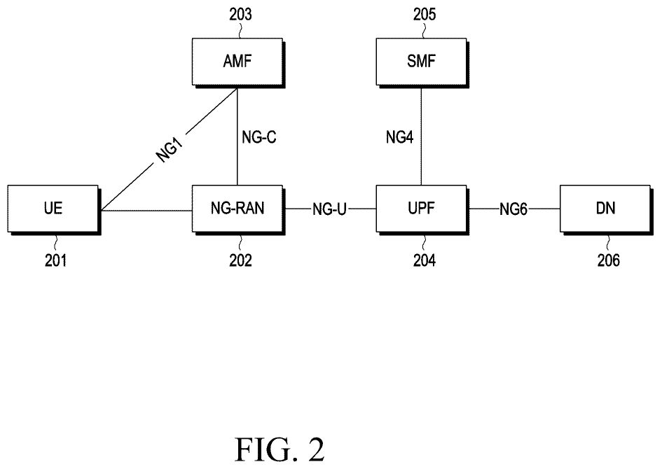

FIG. 2 is an exemplary system architecture 200 according to various embodiments of the present disclosure. Other embodiments capable of using the system architecture 200 do not depart from the scope of the present disclosure.

A User Equipment (UE) 201 is a terminal apparatus for receiving data. A Next Generation Wireless Access Network (NG-RAN, or RAN for short) 202 is a wireless access network, which includes a base station (an gNB, or an eNB connected to 5G core network (5GC), and the eNB connected to 5GC is also called ng-gNB) that provides UE with an access wireless network interface. An Access and Mobility Management Function entity (AMF) 203 is in charge of managing mobility context and security information of the UE. A User Plane Function entity (UPF) 204 mainly provides the functions of a user plane. A Session Management Function entity (SMF) 205 is in charge of session management. A Data Network (DN) 206 includes, for example, operator services, Internet access, third-party services, and the like. An interface between the AMF 203 and the NG-RAN 202 is called a NG-C interface, or a NG interface, or a N2 interface. An interface between the UPF 204 and the NG-RAN 202 is called a NG-U interface, or a N3 interface, a signaling between the UE and the AMF 203 is called Non-Access Stratum Signaling (NAS), or a N1 interface. An interface between base stations is called a Xn interface.

In the following embodiments, the 5G system is taken as an example, the access network takes a separate architecture as an example, and the access network is divided into a control plane CU-CP, a user plane CU-UP and a distribution unit DU. For convenience of description, the CU-CP and the CU-UP are in the same entity. The method is also applicable to a non-separation architecture and the corresponding entities of other systems.

In order to make effective use of air interface resources, for services in which there are multiple receiving users receive the same data, service data are provided to users using a manner of broadcast and multicast. In addition to air interface resource sharing, resources of the access network and the core network may also be shared. This service is called a Multimedia Broadcast Multicast Service, hereinafter referred to as a MBS (Multicast and Broadcast Service).

MBS services are divided into two types, of which one is a multicast service, that is, the UE firstly needs to join the multicast service, and then when the multicast service starts, if the UE is in an idle mode of Packet Mobility Management (PMM), the network sends a paging message to make the UE enter a PMM connection mode to accept services. The other is a broadcast service, that is, the UE does not need to join a certain group, and start information and configuration information of services is sent to the UE through a manner of broadcast, and all the PMM connection modes and PMM idle modes may receive data.

The power of the UE is limited, and in order to save power for the UE, if the UE does not have other services, it is not necessary to put the UE in a radio resource control (RRC) connection mode to receive data, the UE may enter a RRC inactive status and receive data of the multicast service through Discontinuous Reception (DRX).

When the MBS is the multicast service, the multicast service may only be received by users joined to a multicast group, and the MBS service is identified by the service identifier TMGI. Within a period of time, if the multicast service has no data to send, the MBS User Plane Node (MB-UPF) may decide to initiate a deactivation process, and the MBS service enters an inactive status. The core network sends a deactivation request message to the NG-RAN base station, the user planes of the NG-RAN base station and the core network may be released after the deactivation process. When the MB-UPF receives downlink data, the MB-UPF notifies a MBS Session Management Function Node (MB-SMF) to initiate an activation process and activate the user plane for transmitting the MBS service. Before the activation, the core network configure, for the UE, a corresponding relation between a unicast QoS flow and a multicast QoS flow, and when the UE moves to a network without a MBS multicast transmission capability, an unicast transmission channel is configured with the corresponding relation to transmit MBS data.

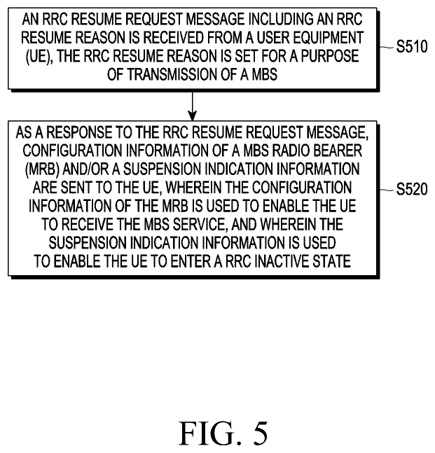

FIG. 5 is a flowchart showing a method, performed by a CU of a second base station, for supporting multicast transmission according to an exemplary embodiment of the present disclosure, wherein the second base station includes the CU and at least one DU. Detailed descriptions of the steps unrelated to the present invention is omitted here.

As shown in FIG. 5, in step S510, an RRC resume request message including an RRC resume reason is received from a User Equipment (UE), wherein the RRC resume reason is set for a purpose of transmission of a MBS.

In step S520, configuration information of a MBS Radio Bearer (MRB) and/or a suspension indication information are sent to the UE, as a response to the RRC resume request message, wherein the configuration information of the MRB is used to enable the UE to receive the MBS service, and wherein the suspension indication information is used to enable the UE to enter a RRC inactive status.

The sending the configuration information of the MRB and/or the suspension indication information to the UE includes: sending a UE context establishment request message to the DU of the second base station, wherein the configuration information of the MRB and/or the suspension indication information are included in a RRC container in the UE context establishment request message; sending the configuration information of the MRB and/or the suspension indication information to the UE through a RRC message via the DU of the second base station.

The configuration information of the MRB and/or the suspension indication information are included in a RRC resume message or a RRC reconfiguration request message in the RRC container.

The sending the configuration information of the MRB and/or the suspension indication information to the UE via the DU of the second base station includes sending the configuration information of the MRB and/or the suspension indication information to the UE through the RRC resume message or the RRC reconfiguration request message via the DU of the second base station.

The UE context establishment request message further includes identification information of the MBS, Quality of Service (QOS) information of the MBS and an uplink transmission layer address for the MBS.

The sending the configuration information of the MRB and/or the suspension indication information to the UE includes: sending a RRC message transmission including a RRC resume message or a RRC reconfiguration request message to the DU of the second base station, wherein the configuration information of the MRB and/or the suspension indication information are included in the RRC resume message or the RRC reconfiguration request message; sending the configuration information of the MRB and/or the suspension indication information to the UE through the RRC resume message or the RRC reconfiguration request message via the DU of the second base station.

The sending the configuration information of the MRB and/or the suspension indication information to the UE includes sending a RRC connection release request message to the UE, wherein the configuration information of the MRB and/or the suspension indication information are included in the RRC connection release request message.

The method further includes: receiving a RAN paging message including identification information of the MBS from the CU of a first base station; and sending the RAN paging message to the DU of the second base station.

The RAN paging message further includes information for indicating that a paging reason is the MBS.

The RAN paging message is a RAN paging message for a single UE or a RAN group paging message for a plurality of UEs.

The method further includes: sending an retrieve UE context request message including indication information of the MBS to the CU of the first base station, wherein the indication information is used to indicate that a sending reason of UE context information is the MBS; receiving an retrieve UE context response message including context information of the UE from the CU of the first base station.

The retrieve UE context request message further includes identification information of the MBS.

The retrieve UE context response message further includes a corresponding relation between a unicast QoS flow and a multicast QoS flow, the identification information of the MBS, and QoS information of the MBS.

The retrieve UE context response message further includes indication information for indicating whether the MBS is in an active status.

Through the above methods, it may reduce additional signaling overhead of multicast data transmission, increase access efficiency of access network resources and/or air interface resources, reduce transmission delay, and enable the UE to receive data of multicast services in an energy-saving manner.

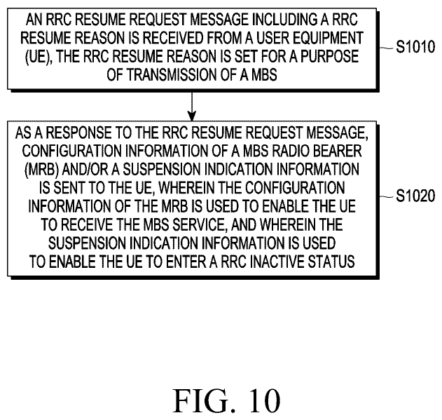

FIG. 10 is a flowchart showing a method, performed by a DU of a second base station, for supporting multicast transmission according to an exemplary embodiment of the present disclosure, wherein the second base station includes a CU and at least one DU.

As shown in FIG. 10, in step S1010, an RRC resume request message including a RRC resume reason is received from a User Equipment (UE), the RRC resume reason is set for a purpose of transmission of a MBS.

In step S1020, configuration information of a MBS Radio Bearer (MRB) and/or suspension indication information is sent to the UE, as an response to the RRC resume request message, wherein the configuration information of the MRB is used to enable the UE to receive the MBS service, and wherein the suspension indication information is used to enable the UE to enter a RRC inactive status.

The method further includes receiving the configuration information of the MRB and/or the suspension indication information from the CU of the second base station.

The receiving the configuration information of the MRB and/or the suspension indication information from the CU of the second base station includes: receiving a UE context establishment request message from the CU of the second base station, wherein the configuration information of the MRB and/or the suspension indication information are included in a RRC container in the UE context establishment request message.

The configuration information of the MRB and/or the suspension indication information are included in a RRC resume message or a RRC reconfiguration request message in the RRC container.

The UE context establishment request message further includes identification information of the MBS, Quality of Service (QOS) information of the MBS, and an uplink transmission layer address for the MBS.

The receiving the configuration information of the MRB and/or the suspension indication information from the CU of the second base station includes: receiving a RRC message transmission including a RRC resume message or a RRC reconfiguration request message from the CU of the second base station, wherein the configuration information of the MRB and/or the suspension indication information are included in the RRC resume message or the RRC reconfiguration request message.

The sending the configuration information of the MRB and/or the suspension indication information to the UE includes: sending the configuration information of the MRB and/or the suspension indication information to the UE through the RRC resume message or the RRC reconfiguration request message.

The sending the configuration information of the MRB and/or the suspension indication information to the UE includes: sending, to the UE, a RRC connection release request message received form the CU of the second base station, wherein the configuration information of the MRB and/or the suspension indication information are included in the RRC connection release request message.

The method further includes: receiving a RAN paging message including identification information of the MBS from the CU of the second base station; and sending the RAN paging message to the UE.

The RAN paging message further includes information for indicating that a paging reason is the MBS.

The RAN paging message is a RAN paging message for a single UE or a RAN group paging message for a plurality of UEs.

Through the above methods, it may reduce additional signaling overhead of multicast data transmission, increase access efficiency of access network resources and/or air interface resources, reduce transmission delay, and enable the UE to receive data of multicast services in an energy-saving manner.

Besides, according to an embodiment of the present disclosure, a method performed by a UE in a communication system may be further provided, wherein the method includes: sending, a Radio Resource Control (RRC) resume request message including a RRC resume reason to a Distributed Unit (DU) of a second base station, the RRC resume reason is set for a purpose of transmission of a Multimedia Broadcast Multicast Service (MBS); receiving configuration information of a MBS Radio Bearer (MRB) and/or suspension indication information from the DU of the second base station, wherein the configuration information of the MRB is used to enable the UE to receive the MBS service, and wherein the suspension indication information is used to enable the UE to enter a RRC inactive status.

The receiving the configuration information of the MRB and/or the suspension indication information from the DU of the second base station includes: receiving a RRC resume message or a RRC reconfiguration request message from the DU of the second base station, wherein the configuration information of the MRB and/or the suspension indication information are included in the RRC resume message or the RRC reconfiguration request message.

Alternatively, the receiving the configuration information of the MRB and/or the suspension indication information from the DU of the second base station includes: receiving a RRC connection release request message from the DU of the second base station, wherein the configuration information of the MRB and/or the suspension indication information are included in the RRC connection release request message.

The method further includes receiving a RAN paging message including identification information of the MBS from the DU of a second base station. The RAN paging message further includes information for indicating that a paging reason is the MBS. The RAN paging message is a RAN paging message for a single UE or a RAN group paging message for a plurality of UEs.

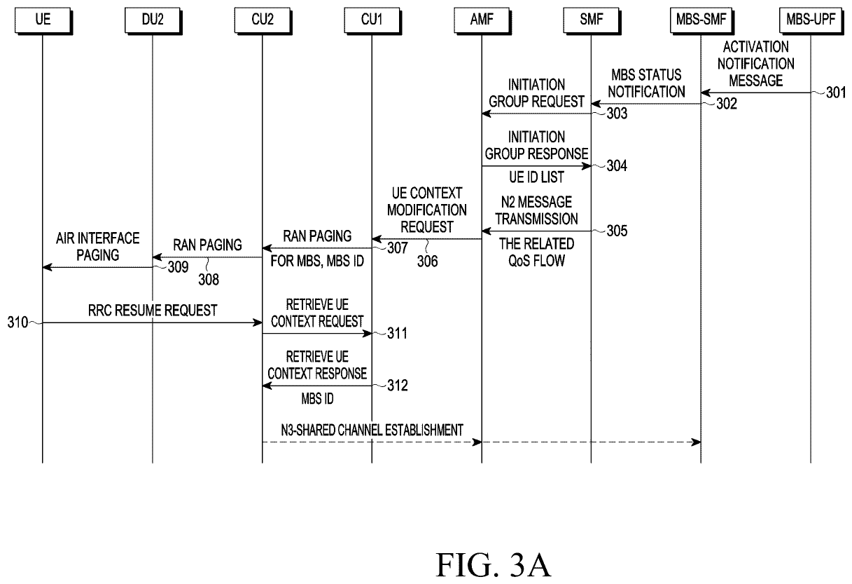

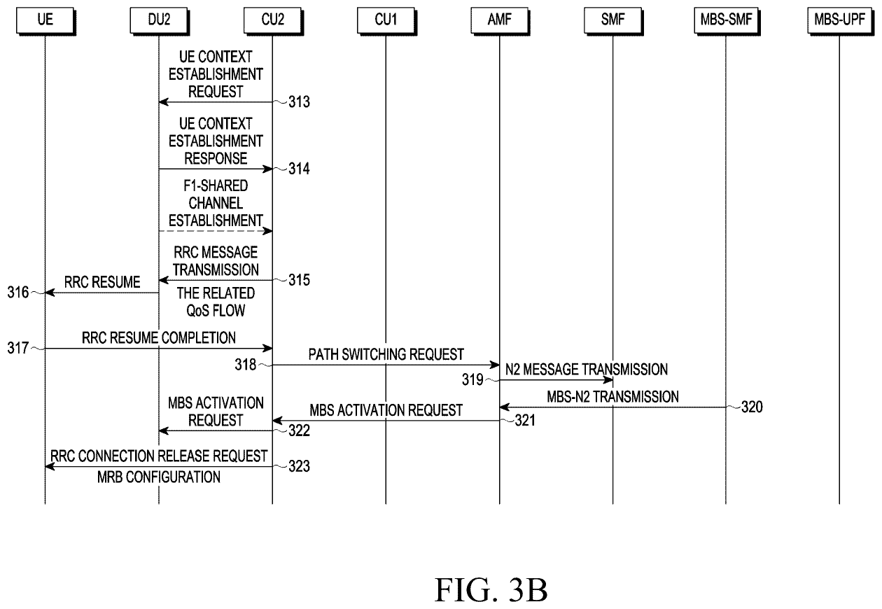

FIGS. 5 and 10 and the steps related to the method performed by the UE in the communication system as described above will be described in detail below with reference to FIGS. 3A to 4B and 6 to 9. In the following description, CU1 and DU1 respectively represent the CU and DU of the first base station, and CU2 and DU2 respectively represent the CU and DU of the second base station.

FIGS. 3A and 3B are a schematic diagram showing a first example of a method for supporting multicast transmission according to an exemplary embodiment of the present disclosure, wherein in the first example described in FIGS. 3A and 3B, a UE in an RRC inactive status has joined a certain MBS group, a core network has not configured the UE with information of unicast QoS Flow associated with the MBS, or has not activated this configuration, and the core network needs to firstly configure/activate the associated unicast session, then send a MBS activation request. In this embodiment, a base station sends MBS bearer information to the UE through a UE-dedicated signaling. The specific process is shown in FIGS. 3A and 3B.

In the following embodiments, CUs all represent centralized units in a separation architecture, and if the centralized units are further separated into control planes CU-CP and user planes CU-UP, the CUs represent the control planes.

In step 301, a MB-UPF receives downlink data of a certain MBS service, and the MB-UPF sends a message to a MB-SMF, to notify the MB-SMF that the downlink MBS data has arrived to the MB-UPF. The name of the message may be a N4mb notification message or an activation notification message and so on, the message contains a session identification of a N4 interface (N4 Session ID), and the message also contains information such as a service identification (TMGI) and so on.

Alternatively, an application layer function entity directly sends a message of MBS activation request to the MB-SMF. This message carries the service identification (TMGI) of the MBS.

In step 302, the MB-SMF sends a message to a Session Management Function entity (SMF) of the UE.

The name of the message in this step may be a MBS status notification message, a MBS context status notification and so on, for example, a Nmbsmf_MBSSession_ContextStatusNotify message, which carries the service identification TMGI and/or activation indication of the MBS, wherein the activation indication may be set as activation or deactivation.

The SMF stores context of the UE and also stores status of a MBS session. According to the message received in step 302, the SMF sets the status of the MBS session to an active status, and finds all UEs joined to this MBS service, from the context of the UE. If the SMF finds that there is at least one UE, among the UEs joined the MBS service, having not activated a Unicast Packet Data Unit session (PDU session) associated with this MBS, the SMF proceeds to the following step 303.

In step 303, the SMF sends a message to a mobile management entity AMF of the UE to request the AMF to determine a connection status of the UE. The name of the message may be request initiation group contact, or may be a Namf_MT_EnableGroupReachability request message, or other names. The message contains a list 1 of the UE. The list 1 of the UE contains identification 1 of the UE, by which the AMF may find the context information of the UE stored on the AMF.

The AMF finds the corresponding context information of each UE for the UE identification 1 in the list 1 of the UE after receiving the message, and proceeds to the following steps 304 and 305.

In step 304, the AMF sends an initiation group contact response message to the SMF, and the name of the message may also be other names. With respect to the list 1 of the UE received in step 303, the AMF searches the stored context information of the each UE, and may know the status of the UE from the context information. On the AMF, a connection management (CM) status of the UE may be a CM-connected mode or a CM-idle mode. The CM-connected mode means that Radio Resource Connection (RRC connection) of an air interface of the UE, and a UE-dedicated connection of an Ng interface have been established, and a non-access stratum signaling connection between the UE and the AMF has been established. The CM-idle mode means that the RRC connection, and the UE-dedicated connection of the Ng interface are not established, and the non-access stratum signaling connection between the UE and the AMF is not established. The AMF forms a list 2 of the UE with the identifications of all UEs in the CM-connected mode, and sends the list 2 of the UE to the SMF in the message of the step 304, wherein the initiation group contact response message of the step 304 contains the list 2 of the UE, which contains the identities of UEs in the CM-connected mode. In this embodiment, the UE is in the RRC inactive status, and the status stored at the AMF is in the CM-connected mode, therefore, the identification of the UE is also included in the identification list 2, the AMF sends the identification list 2 of the UE to the SMF.

In step 305, the SMF sends a message transmission to the AMF. This message contains a container of a session management message, in which the session management message contains identification of the MBS, QoS information of quality configuration information of the MBS, and a corresponding relation between a unicast QoS flow and a multicast QoS flow. The corresponding relation between the unicast QoS flow and the multicast QoS flow is used to transmit a MBS service by unicast data transmission when the UE moves to a network without a MBS multicast transmission capability. The AMF does not parse the session management message, but forwards the same to a NG-RAN. This message may also contain a non-access stratum NAS message to be sent to the UE.

In step 306, the AMF sends a UE context modification request message to the access network NG-RAN. For the separation architecture, the AMF sends the UE context modification request message to the CU1. The UE context modification request message carries the session management message of the step 305, and thus also carries the NAS message to be sent to the UE.

In step 307, the CU1 sends a RAN paging to the CU2.

The CU1 checks the context information of the UE and finds that the UE is in the RRC inactive status. When the UE is in the RRC inactive status, the UE may move within the RAN Notification Area (referred to as RNA) without notifying the CU1, therefore, the CU1 sends the RAN paging message to a DU within the RNA range and controlled by this CU1, and also to all other CUs within the RNA range, for example the CU2 in FIGS. 3A and 3B, the other CUs send RAN paging messages to DUs within the RNA range and controlled by itself.

In the present invention, there are two methods for sending the RAN paging message:
Method 1: the RAN paging message in the step 307 is a RAN paging message for one UE, which carries a RAN paging identification I-RNTI, DRX settings of the paging, a priority of the paging, and a cell identification list of the paging, of the UE, in addition, according to the present invention, this RAN paging message may also contain the identification of the MBS, and/or contains that a paging reason is for the MBS. The DU receives the RAN paging message, and for the same MBS, if a plurality of UEs are in the RRC inactive status, the DU may receive a plurality of RAN paging messages, and in order to save resources of air interfaces, the DU may send a group paging message on the air interface, wherein the group paging message of the air interface contains the identification of the MBS, for example TMGI.
Method 2: if the CU1 receives a plurality of pieces of messages of step 306 from the core network, and each message is for one UE, in order to reduce the number of signaling of a F1 interface, the CU1 may send a group paging message to the DU and all other CUs under the RNA. The group paging message contains the identification of the MBS, DRX information of the paging, priority information of the paging, the identification list of the UE, and the identification list of a cell to send the paging message. The DU receives the group paging message and sends the group paging message on the air interface, the group paging message of the air interface contains the identification of the MBS, for example TMGI.

In step 308, the CU2 sends the RAN paging message to the DU2.

The DU2 is a separation unit controlled by the CU2. The DU2 receives the RAN paging message in the step 308.

In the Method 1, the DU2 receives the paging message for one UE, the DU2 may send the paging message for a certain UE on an air interface, which contains a RAN paging identification I-RNTI of the UE, and the paging reason may be set for the MBS. Alternatively, the DU2 receives the paging message for the one UE, the DU calculates a paging slot of this UE and sends the paging message in this slot, the paging message contains the identification of the MBS, for example TMGI. In this way, other UEs receiving the paging message in this slot may also receive this paging message, and if the other UEs are interested in the MBS, they may also make a corresponding response.

In the Method 2, the DU2 sends the group paging message on the air interface. The group paging message contains the identification of the MBS, for example TMGI. An advantage of using one group paging message is that it saves the resources of the air interface, and one paging message may page all users interested in this MBS.

In step 309, the DU2 sends the paging message of the air interface to the UE.

The UE receives the paging message. In this embodiment, the UE has joined the MBS service, and the UE is currently in the RRC inactive status, in step S310, the UE sends a RRC resume request message to the CU2, wherein the RRC resume request message carries identification of the UE, a base station identification of a previous service, and a cell identification of the previous service. According to the present invention, the RRC resume request message may also carry the identification of the MBS and a RRC resume reason, wherein the resume reason is set for the MBS and indicates that the resume of RRC is requested due to the MBS. This message is forwarded by the DU2 to the CU2.

In step 311, the CU2 sends an retrieve UE context request message to the CU1. The CU2 receives the RRC resume request message and finds a last serving base station (or a last serving CU, called an old CU) of the UE according to information carried in the RRC resume request message. The CU2 (i.e., the new CU) sends the retrieve UE context request message to the CU1 (i.e., the old CU), wherein this retrieve UE context request message carries an old base station identification, an old cell identification, and a user identification C-RNTI of the UE in the old cell. According to the method of the present invention, this retrieve UE context request message also carries indication information of the MBS, which is used to indicate that the context information of the UE is obtained due to the request of the MBS, and may also contain the identification of the MBS. After receiving this retrieve UE context request message in this step, the current mechanism is that the old CU decides whether to send the context information of the UE to the new CU. According to the method of the present invention, the old CU must send the context information of the UE to the new CU according to the above indication information.

In step 312, the CU1 sends a retrieve UE context response message to the CU2. This retrieve UE context response message contains the context information of the UE, and according to the method of the present invention, this retrieve UE context response message also contains the identification of the MBS, the QoS of the MBS, and the corresponding relation between the unicast QoS flow and the multicast QoS flow. This retrieve UE context response message also contains indication information of whether the MBS is activated, wherein the indication information is used to indicate whether the MBS is currently in an activated status or an inactive status. This retrieve UE context response message may also contain NAS containers, wherein the NAS containers contain a NAS container received by the old CU in the step 306.

The CU2 receives this retrieve UE context response message in the step 312, and if this retrieve UE context response message contains information such as the identification of the MBS and so on, the CU2 finds a user plane CU-UP for transmitting the MBS, and sends a message to this CU-UP, for example, sends a MBS bearer establishment request message to this CU-UP, wherein this message may carry one or more of the identification of the MBS, the QoS information of the MBS, and the corresponding relation between the unicast QoS flow and the multicast QoS flow. For one MBS service, the CU2 determines one CU-UP to transmit the MBS service.

The CU-UP sends a MBS bearer establishment response message to the CU2. This MBS bearer establishment response message carries the identification of the MBS and an uplink transmission layer address for the MBS allocated by the CU-UP, wherein the uplink transmission layer address contains an IP address and a channel number of the CU-UP, or the uplink transmission layer address contains the IP address of the CU-UP. The CU-UP allocates one uplink transmission layer address to the same MBS.

If the CU-UP finds that this UE is the first user, under the CU-UP, to join the above MBS service, and the CU-UP enables to support a shared N3 channel, the CU-UP sends a N3-shared channel establishment request message to the CU2, which contains the identification of the MBS and contains the downlink transmission layer address allocated by the CU-UP. The CU2 sends this N3-shared channel establishment request message to the AMF. The AMF forwards this N3-shared channel establishment request message to the MB-SMF, and the MB-SMF forwards this N3-shared channel establishment request message to the MB-UPF, to establish a N3-shared channel corresponding to this MBS.

In step 313, the CU2 sends a UE context establishment request message to the DU2. This UE context establishment request message contains configuration information of a Data Radio Bearer (DRB) of the UE, configuration information of a Signaling Radio Bearer (SRB), and so on. According to the method of the present invention, this UE context establishment request message also contains the identification of the MBS, contains the QoS information of the MBS, and further contains the uplink transmission layer address for the MBS allocated by the CU-UP. The uplink transmission layer address contains the IP address of the CU-UP and the channel identification allocated by the CU-UP. According to the method of the present invention, this UE context establishment request message may also carry a RRC container, which contains an RRC resume message or an RRC reconfiguration request message. If the CU knows that the MBS is currently in an active status, the CU may determine the configuration information of the MBS radio bearer, and send the configuration information of the MRB to the UE through the RRC reconfiguration request message or the RRC resume message. The RRC reconfiguration request message or the RRC resume message may also contain indication information that enables the UE to enter the inactive status, for example a suspend indication, so that the UE may enter the inactive status to receive data of MBS multicast service.

In step 314, the DU2 sends a UE context establishment response message to the CU2. This UE context establishment response message carries information of the DRB which is successfully established.

If the DU2 finds that this UE is the first user, under this DU, to join the above MBS service, the DU2 sends an F1-shared channel establishment request message to the CU2, which contains the identification of the MBS and contains the downlink transmission layer address allocated by the DU2. Thus, a corresponding F1-shared channel is established for this MBS.

In step 315, the CU2 sends a downlink RRC message transmission to the DU2, wherein the downlink RRC message transmission carries the RRC resume message or the RRC reconfiguration request message, and in addition, the RRC resume message or the RRC reconfiguration request message may also be carried in the step 313, and then this step may be omitted. The RRC reconfiguration request message or the RRC resume message may also contain indication information that enables the UE to enter the inactive status, for example the suspend indication, so that the UE may enter the inactive status to receive data of the MBS multicast service. The RRC reconfiguration request message or RRC resume message may also include the NAS message. Alternatively, in the step 315, an RRC reconfiguration request message may be carried. The RRC reconfiguration request message may carry the NAS message, that is, the CU2 contains the NAS message received in step 312 in the RRC reconfiguration request message and sends the same to the UE.

In step 316, the DU2 forwards the RRC resume message or the RRC reconfiguration request message to the UE.

In step 317, the UE sends a RRC resume completion message to the CU2. Alternatively, the UE sends a RRC configuration request completion message to the CU2. The message may carry a NAS response message sent by the UE. This message is forwarded to the CU2 by the DU2.

If the message sent in the step 316 is the RRC resume message and the CU2 has the NAS message to be sent to the UE, the CU2 sends the RRC reconfiguration request message carrying the NAS container to the UE after the step 317. After that, the UE sends the RRC reconfiguration completion message to the CU2. Thus, the NAS messages sent by the core network are sent to the UE. Alternatively, after the CU2 receives the RRC resume completion message sent by the UE, the CU2 sends a path switching request message to the AMF of the core network, and the AMF sends a message carrying the NAS message to the NG-RAN, and then the NG-RAN sends the NAS message to the UE, and since this process is currently supported, so it is omitted here.

In step 318, after the CU2 receives the RRC resume completion message or the RRC reconfiguration completion message, the CU2 sends the path switching request message to the AMF to notify the core network that the UE has switched to the new CU. This path switching request message carries information of the information of accepted MBS quality flow.

In step 319, the AMF sends an N2 message to the SMF, which carries the information of the accepted MBS quality flow.

In step 320, the MB-SMF knows which NG-RANs have established the N3-shared channel, and the MB-SMF sends an activation request message to the AMF node managing this NG-RAN. For example, the MB-SMF sends an N2 transmission message to the AMF, which carries the identification of the MBS and indication of the MBS activation request.

In step 321, the AMF sends the MBS activation request to the CU2. The AMF forwards the message received in the step 320 to the CU2, and if the AMF may know the MBS activation through the step 320, the AMF sends the MBS activation request message to the CU2, which carries the identification of the MBS. Otherwise, the AMF sends an MBS status update message to the CU2, which carries the identification of the MBS.

In step 322, the CU2 sends the MBS activation request to the DU2. The CU2 obtains the identification of the MBS and information that this MBS needs to activate, by analyzing the contents in the message in the step 321. The CU2 sends an activation request message to the DU2, which carries the indication information of the MBS and may also contain the QoS configuration information of the MBS. The QoS information of the MBS has been stored on the CU2, and the QoS information of the MBS may be sent to the DU2 in this step.

In step 323, the CU2 determines the configuration information of the MBS Radio Bearer (MRB) according to the identification of the MBS and the QoS information of the MBS contained in the context of the UE, and if the UE has no other unicast session, the UE may enter the inactive status to receive the MBS service, the CU2 sends the RRC release request message to the UE, wherein this message may also carry the indication information that enables the UE to enter the inactive mode, that is, this RRC release request message carries the configuration information of the MRB, also carries the indication information for the UE to enter the inactive status. This message is forwarded to the UE by the DU2, and the UE may establish the MRB after receiving the RRC release request message and enter the inactive status to receive the MBS service.

Through the above methods, it may reduce additional signaling overhead of multicast data transmission, increase access efficiency of access network resources and/or air interface resources, reduce transmission delay, and enable the UE to receive data of multicast services in an energy-saving manner.

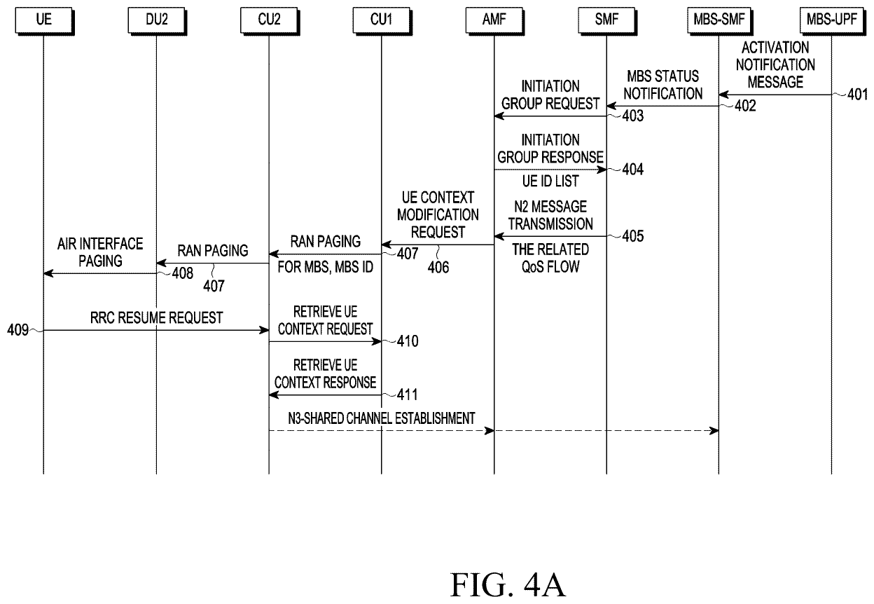

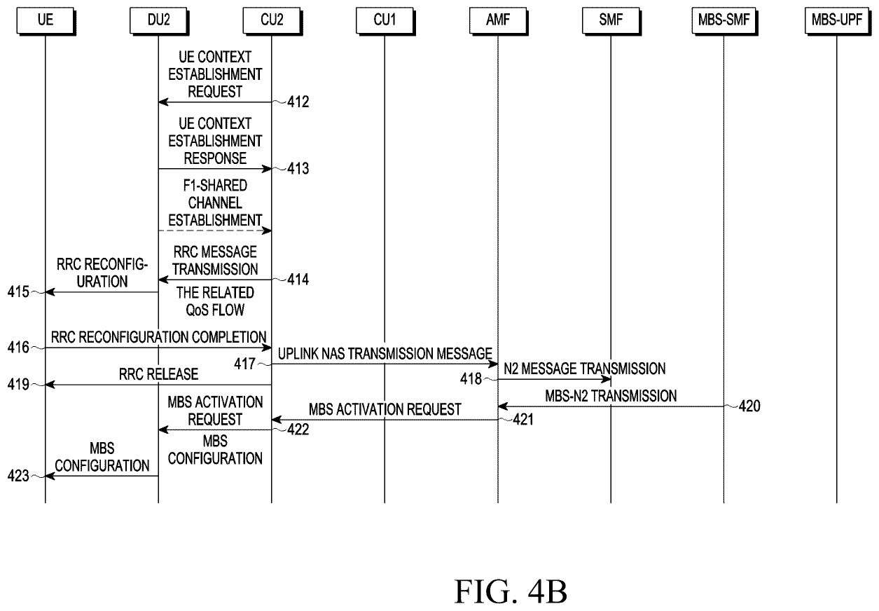

FIGS. 4A and 4B are a schematic diagram showing a second example of a method for supporting multicast transmission according to an exemplary embodiment of the present disclosure. In this example, a UE in an inactive RRC status has joined a certain MBS group, a core network has not configured the UE with information of unicast QoS Flow associated with the MBS, or has not activated this configuration, and the core network needs to firstly configure/activate the associated unicast session, then send a MBS activation request. In this embodiment, a base station sends MBS bearer information to the UE through a common signaling. The specific activation process is shown in FIGS. 4A and 4B.

In step 401, a MB-UPF receives downlink data of a certain MBS service, and the MB-UPF sends a message to a MB-SMF, to notify the MB-SMF that the downlink MBS data has arrived to the MB-UPF. The name of this message may be a N4mb notification message or an activation notification message and so on, this message contains a session identification of a N4 interface (N4 session ID), and this message also contains information such as a service identification (TMGI) and so on.

Alternatively, an application layer function entity directly sends a message of MBS activation request to the MB-SMF. This message carries the service identification (TMGI) of the MBS.

In step 402, the MB-SMF sends a message to a Session Management Function entity (SMF) of the UE.

The name of the message in this step may be a MBS status notification message, a MBS context status notification and so on, for example, a Nmbsmf_MBSSession_ContextStatusNotify message, which carries the service identification TMGI and/or activation indication of the MBS, wherein the activation indication may be set as activation or deactivation.

The SMF stores context of the UE and also stores status of a MBS session. According to the message received in step 402, the SMF sets the status of the MBS session to an active status, and finds all UEs joining to this MBS service, from the context of the UE. If the SMF finds that there is at least one UE, among the UEs joined the MBS service, having not activated a Unicast Packet Data Unit session (PDU session) associated with this MBS, the SMF proceeds to the following step 403.

In step 403, the SMF sends a message to a mobile management entity AMF of the UE to request the AMF to determine a connection status of the UE. The name of the message may be request initiation group contact, or may be a Namf_MT_EnableGroupReachability request message, or other names. The message contains a list 1 of the UE. The list 1 of the UE contains identification 1 of the UE, by which the AMF may find the context information of the UE stored on the AMF.

The AMF finds the corresponding context information of each UE for the UE identification 1 of in the UE list 1 after receiving the message, and proceeds to the following steps 404 and 405.

In step 404, the AMF sends an initiation group contact response message to the SMF, and the name of the message may also be other names. With respect to the list 1 of the UE received in step 403, the AMF searches the stored context information of the each UE, and may know the status of the UE from the context information. On the AMF, a connection management (CM) status of the UE may be a CM-connected mode or a CM-idle mode. The CM-connected mode means that Radio Resource Connection (RRC connection) of an air interface of the UE, and a UE-dedicated connection of an Ng interface have been established, and a non-access stratum signaling connection between the UE and the AMF has been established. The CM-idle mode means that the RRC connection, and the UE-dedicated connection of the Ng interface are not established, and the non-access stratum signaling connection between the UE and the AMF is not established. The AMF forms a list 2 of the UE with the identifications of all UEs in the CM-connected mode, and sends the list 2 of the UE to the SMF in the message of the step 404, wherein the initiation group contact response message of the step 404 contains the list 2 of the UE, which contains the identities of UEs in the CM-connected mode. In this embodiment, the UE is in the RRC inactive status, and the status stored at the AMF is in the CM-connected mode, therefore, the identification of the UE is also included in the identification list 2, the AMF sends the identification list 2 of the UE to the SMF.

In step 405, the SMF sends a N2 message transmission to the AMF. This N2 message transmission contains a container of a session management message, in which the session management message contains identification of the MBS, QoS information of quality configuration information of the MBS, and a corresponding relation between a unicast QoS flow and a multicast QoS flow. The corresponding relation between the unicast QoS flow and the multicast QoS flow is used to transmit a MBS service by unicast data transmission when the UE moves to a network without a MBS multicast transmission capability. The AMF does not parse the session management message, but forwards the same to a NG-RAN.

In step 406, the AMF sends a UE context modification request message to the access network NG-RAN. For the separation architecture, the AMF sends the UE context modification request message to the CU1. The UE context modification request message carries the session management message of the step 405.

In step 407, the CU1 sends a RAN paging to the CU2.

The CU1 checks the context information of the UE and finds that the UE is in the RRC inactive status. When the UE is in the RRC inactive status, the UE may move within the RAN Notification Area (referred to as RNA) without notifying the CU1, therefore, the CU1 sends the RAN paging message to a DU within the RNA range and controlled by this CU1, and also to all other CUs within the RNA range, for example the CU2, and the other CUs send RAN paging messages to DUs within the RNA range and controlled by itself.

In the present invention, there are two methods for sending the RAN paging message:
Method 1: the RAN paging message in the step 407 is a RAN paging message for one UE, which carries a RAN paging identification I-RNTI, DRX settings of the paging, a priority of the paging, and a cell identification list of the paging, of the UE, in addition, according to the present invention, the message may also contain the identification of the MBS, and/or contains that a paging reason is for the MBS. The DU receives the RAN paging message, and for the same MBS, if a plurality of UEs are in the RRC inactive status, the DU may receive a plurality of RAN paging messages, in order to save resources of air interfaces, the DU may send a group paging message on the air interface, wherein the group paging message of the air interface contains the identification of the MBS, for example TMGI.
Method 2: if the CU1 receives a plurality of pieces of messages of step 406 from the core network, and each message is for one UE, in order to reduce the number of signaling of a F1 interface, the CU1 may send a group paging message to the DU and all other CUs under the RNA. The group paging message contains the identification of the MBS, DRX information of the paging, priority information of the paging, and the identification list of a cell to send the paging message. The DU receives the group paging message and sends the group paging message on the air interface, wherein the group paging message of the air interface contains the identification of the MBS, for example TMGI.

In step 408, the DU2 receives the RAN paging message in the step 407. In the step 407, the CU2 sends the RAN paging message to the DU2. The DU2 sends the paging message of the air interface to the UE.

In method 1, the DU2 receives the paging message for the one UE, the DU2 calculates a paging slot of this UE and sends the paging message for a certain UE in this slot, the paging message contains a RAN paging identification I-RNTI of the UE, and the paging reason may be set for the MBS. Alternatively, DU may use a group paging at the air interface, and the paging message of the air interface contains the identification of the MBS, for example TMGI. Alternatively, the DU2 receives the paging message for the one UE, the DU calculates a paging slot of this UE and sends the paging message in this slot, the paging message contains the identification of the MBS, for example TMGI. In this way, other UEs receiving the paging message in this slot may also receive this paging message, and if the other UEs are interested in the MBS, they may also make a corresponding response.

In the Method 2, the DU sends the group paging message on the air interface. The group paging message contains the identification of the MBS, for example TMGI. One group paging message may be used to page all users interested in this MBS.

In step 409, the UE sends a RRC resume request message to the CU2. The message is forwarded by the DU2.

The UE receives the paging message. In this embodiment, the UE has joined the MBS service, and the UE is currently in the RRC inactive status, the UE sends the RRC resume request message to the CU2, wherein the RRC resume request message carries identification of the UE, a base station identification of a previous service, and a cell identification of the previous service. According to the present invention, the message may also carry the identification of the MBS (for example, TMGI) and a RRC resume reason, wherein the resume reason is set for the MBS and indicates that the resume of RRC is requested due to the MBS.

In step 410, the CU2 sends an retrieve UE context request message to the CU1. The CU2 receives the RRC resume request message and finds a last serving base station (or a last serving CU, called an old CU) of the UE according to information carried in the RRC resume request message. The CU2 (i.e., the new CU) sends the retrieve UE context request message to the CU1 (i.e., the old CU), this retrieve UE context request message carries an old base station identification, an old cell identification, and a user identification C-RNTI of the UE in the old cell. According to the method of the present invention, this retrieve UE context request message may also carry the identification of the MBS or/and also carries indication information of the MBS, which is used to indicate that the context information of the UE is obtained due to the request of the MBS. After receiving this retrieve UE context request message in this step, the current mechanism is that the old CU decides whether to send the context information of the UE to the new CU. According to the method of the present invention, the old CU must send the context information of the UE to the new CU according to the above indication information.

In step 411, the CU1 sends an retrieve UE context response message to the CU2. This retrieve UE context response message contains the context information of the UE, and according to the method of the present invention, this retrieve UE context response message also contains the identification of the MBS, the QoS of the MBS, and the corresponding relation between the unicast QoS flow and the multicast QoS flow. This retrieve UE context response message also contains indication information of whether the MBS is activated, wherein the indication information is used to indicate whether the MBS is currently in an activated status or an inactive status. This retrieve UE context response message may also contain NAS containers, wherein the NAS containers contain a NAS container received by the old CU in the step 406.

The CU2 receives this retrieve UE context response message in the step 411, and if this retrieve UE context response message contains information such as the identification of the MBS and so on, the CU2 finds a CU-UP for transmitting the MBS, and sends a message to this CU-UP, for example, sends a MBS bearer establishment request message to this CU-UP, this message may carry one or more of the identification of the MBS, the QoS information of the MBS, and the corresponding relation between the unicast QoS flow and the multicast QoS flow. For one MBS service, the CU2 determines one CU-UP to transmit the MBS service.

The CU-UP sends the MBS bearer establishment response message to the CU2. This MBS bearer establishment response message carries the identification of the MBS and an uplink transmission layer address for the MBS allocated by the CU-UP, wherein the uplink transmission layer address contains an IP address and a channel number of the CU-UP, or the uplink transmission layer address contains the IP address of the CU-UP. The CU-UP allocates one uplink transmission layer address to the same MBS.

If the CU-UP finds that this UE is the first user, under the CU-UP, to join the above MBS service, and the CU-UP enables to support a shared N3 channel, the CU-UP sends a N3-shared channel establishment request message to the CU2, which contains the identification of the MBS and contains the downlink transmission layer address allocated by the CU-UP. The CU2 sends this N3-shared channel establishment request message to the AMF. The AMF forwards this N3-shared channel establishment request message to the MB-SMF, and the MB-SMF forwards this N3-shared channel establishment request message to the MB-UPF, to establish a N3-shared channel corresponding to this MBS.

In step 412, the CU2 sends a UE context establishment request message to the DU2. This UE context establishment request message contains configuration information of a DRB of the UE, configuration information of a SRB, and so on. According to the method of the present invention, this UE context establishment request message also contains the identification of the MBS, contains the QoS information of the MBS, and further contains the uplink transmission layer address for the MBS allocated by the CU-UP. The uplink transmission layer address contains the IP address of the CU-UP and the channel identification allocated by the CU-UP. According to the method of the present invention, this UE context establishment request message may also carry an RRC container, which contains an RRC resume message or an RRC reconfiguration request message. If the CU knows that the MBS is currently in an active status, the CU may determine the configuration information of the MRB, and send the configuration information of the MRB to the UE through the RRC reconfiguration request message or the RRC resume message. The RRC reconfiguration request message or RRC resume message may also contain indication information that enables the UE to enter the inactive status, so that the UE may enter the inactive status to receive data of MBS multicast service. If there is a NAS message to be sent to the UE, the RRC reconfiguration request message or the RRC resume message contains the NAS message.

In step 413, the DU2 sends a UE context establishment response message to the CU2. This UE context establishment response message carries information of the DRB which is successfully established.

If the DU finds that the UE is the first user, under this DU, to join the above MBS service, the DU sends an F1-shared channel establishment request message to the CU, which contains the identification of the MBS and contains the downlink transmission layer address allocated by the DU2. Thus, a corresponding F1-shared channel is established for this MBS.

In step 414, the CU2 sends a downlink RRC message to the DU2.

The downlink RRC message carries the RRC container, which may carry the RRC resume request message. In addition, the RRC resume request message may also be carried in the step 412, so this step may be omitted.

According to a method of the present invention, in step 414, the RRC container may carry an RRC reconfiguration request message. The RRC reconfiguration request message may carry the NAS message, that is, the CU2 includes the NAS message received in step 411 in the RRC reconfiguration request message and sends it to the UE.

According to a method of the present invention, in step 414, the RRC container may carry a RRC release request message, which indicates that the UE enters the RRC inactive status.

In step 415, the DU2 forwards the RRC message to the UE. The DU2 forwards the RRC message received in the step 414 to the UE.

In step 416, the UE sends a RRC reconfiguration completion message to the CU2. This RRC reconfiguration completion message may carry a NAS response message sent by the UE. If the UE receives the RRC reconfiguration request message, the UE sends the RRC reconfiguration completion message to the CU2.

If the message sent in the step 415 is the RRC resume request message, and the CU2 has a NAS message to be sent to the UE, the CU2 sends the RRC reconfiguration request message carrying the NAS container to the UE after step 416. After that, the UE sends the RRC reconfiguration completion message to the CU2. Thus, the NAS messages sent by the core network are sent to the UE. Alternatively, after the CU2 receives the RRC resume completion message sent by the UE, the CU2 sends a path switching request message to the AMF of the core network, and the AMF sends a message carrying the NAS message to the NG-RAN, and then the NG-RAN sends the NAS message to the UE, and since this process is currently supported, so it is omitted here.

In step 417, after the CU2 receives the RRC reconfiguration completion message or the RRC resume completion message, the CU2 sends the path switching request message to the AMF to notify the core network that the UE has switched to the new CU2. This path switching request message carries information of the information of accepted MBS quality flow. This path switching request message may carry the NAS message sent by the UE.

In step 418, the AMF sends an N2 message to the SMF, which carries the information of accepted MBS quality flow. This N2 message may also carry the NAS message sent by the UE.

In step 419, the CU2 sends the RRC connection release request message to the UE, wherein the RRC connection release request message is sent to the DU2, which sends the RRC transmission message to the UE.

In step 420, the MB-SMF knows which NG-RANs have established the N3-shared channel, and the MB-SMF sends an activation request message to the AMF node managing this NG-RAN. For example, the MB-SMF sends an N2 transmission message to the AMF, which carries the identification of the MBS and indication of the MBS activation request.

In step 421, the AMF sends the MBS activation request to the CU2. The AMF knows that the CU2 has established the N3-shared channel, and the AMF sends a message to the CU2, if the AMF may know the MBS activation through the step 420, the AMF sends the MBS activation request message to the CU2, which carries the identification of the MBS. Otherwise, the AMF sends an MBS status update message to the CU2, which carries the identification of the MBS.

In step 422, the CU2 sends the MBS activation request to the DU2. The CU2 obtains the identification of the MBS and information that this MBS needs to activate, by analyzing the contents in the message in the step 421, and the CU2 knows it has established the F1-shared channel with the DU, and the CU2 sends an activation request message to the DU, which carries the indication information of the MBS, for example the identification of the MBS and a service area of the MBS. If the QoS information of the MBS has been stored on the CU2, the QoS information of the MBS may be sent to the DU in this step.

The CU2 determines the configuration information of the MBS Radio Bearer (MRB) according to the identification of the MBS and the QoS information of the MBS contained in the UE context, and the message in the step 422 may also carry the configuration information of the MBS radio bearer. Alternatively, according to the QoS information of the MBS, the CU2 may also determine the configuration information of a Packet Data Convergence Protocol (PDCP) of the MBS radio bearer, and the DU determines the configuration information of a RLC and a MAC of the MBS radio bearer, the message in the step 422 may carry the configuration information of the PDCP of the MRB.

In step 423, the DU2 sends the configuration information of the MBS radio bearer on the air interface through a common channel. The configuration information of the MBS radio bearer contains the identification information of MBS and the configuration of the transmission MBS bearer.

Through the above method, it may reduce additional signaling overhead of multicast data transmission, increase access efficiency of access network resources and/or air interface resources, reduce transmission delay, and enable the UE to receive data of multicast services in an energy-saving manner.

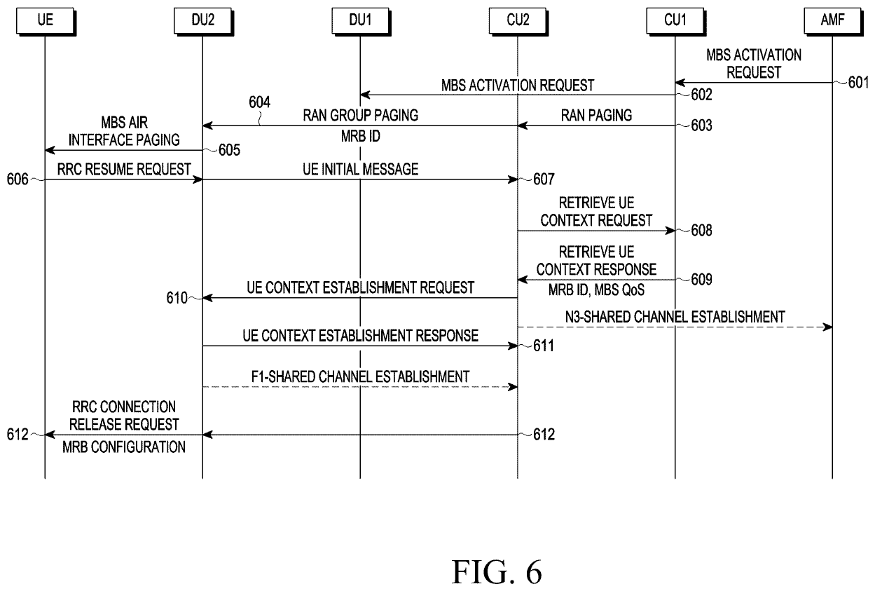

FIG. 6 shows a schematic diagram of a third example of a method for supporting multicast transmission according to an exemplary embodiment of the present disclosure. In this example, one UE in an inactive RRC status has joined a certain MBS group, information of unicast QoS Flow associated with the MBS has been configured, the core network sends a MBS activation request to a base station, and the base station sends the MBS bearer configuration information to the UE through the UE-dedicated channel. The specific activation process is shown in FIG. 6.

In step 601, an AMF sends a MBS activation request to the CU1.

A MB-SMF knows which NG-RANs have established the N3-shared channel, in this embodiment, the CU1 has established the N3-shared channel with a MB-UPF, and the MB-SMF sends the activation request message to the AMF node managing this CU1. For example, the MB-SMF sends an N2 transmission message to the AMF, which carries identification of the MBS and indication of the MBS activation request. The AMF sends the received MBS activation message to the CU1, and if the AMF may know an activation status of the MBS, the AMF sends the MBS activation request message to the CU1, which carries the identification of the MBS and a service area of the MBS. Otherwise, the AMF sends a MBS status update message to the CU1, which carries the identification of the MBS and the service area of the MBS.

In step 602, the CU1 sends the MBS activation request message to the DU1.

According to the service area of the MBS, the CU1 sends the MBS activation request message to the DU within this service area. The CU1 knows the identification of the MBS and the service area of the MBS by analyzing the contents in the message in the step 601, and the CU1 sends the MBS activation request message to the DU within this service area. Alternatively, the CU1 knows that the UE has joined the MBS service and that the UE is under a certain DU according to information of the MBS in the stored UE context, and the CU1 sends the MBS activation request message to the DU. The MBS activation request message carries the identification of the MBS and may also contain QoS configuration information of the MBS. The QoS information of the MBS has been stored on the CU1, so the QoS information of the MBS may be sent to the DU in this step. According to the QoS information of the MBS, the CU1 may also determine configuration information of the MRB, and the MBS activation request message may also carry configuration information of a MBS radio bearer. Alternatively, according to the QoS information of the MBS, the CU1 may also determine configuration information of a PDCP of the MBS radio bearer, the DU1 may determine configuration information of a RLC and a MAC of the MBS radio bearer, and the MBS activation request message in the step 602 may carry the configuration information of the PDCP of the MRB.

The present embodiment takes a CU-CP and a CU-UP on one entity as an example, and if the CU-CP and the CU-UP are in different entities, before this step, the CU1 finds the CU-UP transmitting the MBS and sends a message to the CU-UP, for example, sending the MBS activation request message or the MBS bearer establishment request message to the CU-UP, the sent message may carry the identification of the MBS and the QoS information of the MBS, and the CU-UP sends a response message to the CU1. This response message carries the identification of the MBS, and an uplink transmission layer address allocated for the MBS by the CU-UP, wherein the uplink transmission layer address contains an IP address and a channel number of the CU-UP, or the uplink transmission layer address contains the IP address of the CU-UP. The CU-UP allocates one uplink transmission layer address to the same MBS. If the CU-UP finds that this UE is the first user, under the CU-UP, to join the above MBS service, and the CU-UP enables to support a N3-shared channel, the CU-UP sends a N3-shared channel establishment request message to the CU1, which contains the identification of the MBS, and contains the downlink transmission layer address allocated by the CU-UP. The CU1 sends this N3-shared channel establishment request message to the AMF. The AMF forwards the N3-shared channel establishment request message to MB-SMF, and the MB-SMF forwards the N3-shared channel establishment request message to the MB-UPF to establish a N3-shared channel corresponding to this MBS.

In step 603, the CU1 sends a RAN paging message to other CU2s.

The CU1 checks the context of the UE, and determines the configuration information of the MBS Radio Bearer (MRB) according to the identification of the MBS and the QoS information of the MBS contained in the context of the UE, and if the UE is in a RRC connection mode, the CU1 sends an RRC reconfiguration request message to the UE through the UE-dedicated signaling, and this RRC reconfiguration request message carries the configuration information of the MRB.

When the UE is in the RRC inactive status, the UE may move within the RAN Notification Area (referred to as RNA) without notifying the CU, and therefore, the CU1 sends the RAN paging message to a DU within the RNA range and controlled by the CU1, and also to all other CU2s within the RNA range, the other CU2s send the RAN paging message to DUs controlled by itself and within the RNA range.

In the present invention, there are two methods for sending the RAN paging message:
Method 1: the RAN paging message in the step 603 is a RAN paging message for one UE, which carries a RAN paging identification I-RNTI, DRX settings of the paging, a priority of the paging, and a cell identification list of the paging, of the UE, and according to the present invention, this RAN paging message may also contain the identification of the MBS, and/or contains that a paging reason is for the MBS. The DU receives the RAN paging message, and for the same MBS, if a plurality of UEs are in the RRC inactive status, the DU may receive a plurality of pieces of RAN paging messages for UEs, and in order to save resources of air interfaces, the DU may convert the plurality of RAN paging messages for the UEs into paging request messages for the air interface, and may send a group paging message on the air interface, wherein the group paging message of the air interface contains the identification of the MBS, for example TMGI.
Method 2: the CU1 finds that a plurality of UEs are in the RRC inactive status and have joined the same MBS service, the CU1 may generate a group paging request message and send the same to the DU, and other CU2s under the RNA. The group paging message contains the identification of the MBS, DRX information of the paging, priority information of the paging, an identification list of a cell to send the paging message, and an identification list of the paging UE. The DU receives the group paging message and sends the same on the air interface, wherein the group paging message of the air interface contains the identification of the MBS, for example TMGI.

In step 604, the CU2 sends the RAN paging message to the DU2.

As shown in the step 603, the CU2 may send the RAN paging message for one UE or send the group paging message to the DU2. It is omitted here.

In step 605, the DU2 receives the RAN paging message of the step 604. The DU2 sends the paging message on the air interface.
In the Method 1, the DU2 receives the paging message for one UE, the DU2 calculates a paging slot of this UE, the DU2 may send the paging message for a certain UE on the air interface, which contains a RAN paging identification I-RNTI of the UE, and the paging reason may be set for the MBS. Alternatively, the DU2 may use a group paging on the air interface, and the group paging message of the air interface contains the identification of the MBS, for example TMGI. Alternatively, the DU receives a paging message for one UE, the DU calculates the paging slot of this UE and sends the paging message in this slot, and the paging message contains the identification of the MBS, for example TMGI. In this way, other UEs receiving the paging message in this slot may also receive this paging message, and if the other UEs are interested in the MBS, they may also make a corresponding response.
In method 2, the DU2 sends the group paging message on the air interface. The group paging message contains the identification of the MBS, for example TMGI. One group paging message may be used to page all users interested in the MBS.

In step 606, the UE receives the paging message, in this embodiment, the UE has joined the MBS service, and the UE is currently in the RRC inactive status, the UE sends an RRC resume request message to the DU2, which carries the identification of the UE (e.g., I-RNTI), a base station identification of a previous service, and a cell identification of the previous service. According to the present invention, this RRC resume request message may also carry resume reason, which is set for the MBS and indicates that the resume of the RRC is requested due to the MBS, the RRC resume request message may also carry the identification of the MBS.

In step 607, the DU2 sends an uplink UE initial message to the CU2, which carries the RRC resume request message.

In step 608, the CU2 sends an retrieve UE context request message to the CU1. The CU2 receives the RRC resume request message and finds a last serving base station (or a last serving CU, called the old CU) of the UE according to information carried in the RRC resume request message. The CU2 sends the retrieve UE context request message to the old CU (i.e., the CU1), which carries an old base station identification, an old cell identification, and a user identification C-RNTI of the UE in the old cell. According to the method of the present invention, this retrieve UE context request message also carries indication information of the MBS, which is used to indicate that the context information of the UE is obtained due to the request of the MBS. Alternatively, this retrieve UE context request message carries the identification of the MBS. After receiving the message in this step, the current mechanism is that the old CU decides whether to send the context information of the UE to the new CU (i.e., the CU2). According to the method of the present invention, the old CU must send the context information of the UE to the new CU according to the above indication information.

In step 609, the CU1 sends an retrieve UE context response message to the CU2.

This retrieve UE context response message contains the context information of the UE, and according to the method of the present invention, this retrieve UE context response message also contains the identification of the MBS, a QoS of the MBS, and a corresponding relation between a unicast QoS flow and a multicast QoS flow. This retrieve UE context response message also contains indication information of whether the MBS is activated, which is used to indicate whether the MBS is currently in an activated status or an inactive status.

The CU2 receives this retrieve UE context response message in the step 609, and if this retrieve UE context response message contains information such as the identification of the MBS and so on, the CU2 finds a CU-UP for transmitting the MBS and sends a message to this CU-UP, for example, sends a MBS bearer establishment request message to the CU-UP, which may carry one or more of the identification of the MBS, the QoS information of the MBS, and the corresponding relation between the unicast QoS flow and the multicast QoS flow. For one MBS service, the CU determines one CU-UP to transmit the MBS service.

The CU-UP sends a MBS bearer establishment response message to the CU. This MBS bearer establishment response message carries the identification of the MBS and an uplink transmission layer address for the MBS allocated by the CU-UP, wherein the uplink transmission layer address contains an IP address and a channel number of the CU-UP, or the uplink transmission layer address contains the IP address of the CU-UP. The CU-UP allocates one uplink transmission layer address to the same MBS.

If the CU-UP finds that, this UE is the first user, under the CU-UP, to join the above MBS service, and the CU-UP enables to support a N3-shared channel, the CU-UP sends a N3-shared channel establishment request message to the CU, which contains the identification of the MBS and contains the downlink transmission layer address allocated by the CU-UP. The CU sends this message to the AMF. The AMF forwards this message to the MB-SMF, and the MB-SMF forwards this message to the MB-UPF, to establish a N3-shared channel corresponding to this MBS.

In step 610, the CU2 sends a UE context establishment request message to the DU2. This UE context establishment request message contains configuration information of a bearer of the UE and configuration information of SRB. According to the method of the present invention, this UE context establishment request message also contains the identification of the MBS, contains the QoS information of the MBS, and also contains the uplink transmission layer address allocated for the MBS by the CU-UP. The uplink transmission layer address contains the IP address of the CU-UP and the channel identification allocated by the CU-UP. If this UE is the first MBS user on the DU, the CU2 may send the UE context establishment request message of the step 610, and this UE context establishment request message may also carry a RRC resume request message to enable the UE to enter the RRC connection mode.

In step 611, the DU2 sends a UE context establishment response message to the CU2. This UE context establishment response message carries information of the bearer which is successfully established.

If the DU2 finds that this UE is the first user, under this DU, to join the above MBS service, the DU2 sends an F1-shared channel establishment request message to the CU2, which contains the identification of the MBS and contains the downlink transmission layer address allocated by the DU2. Thus, a corresponding F1-shared channel is established for this MBS.

In step 612, the CU2 sends a RRC release request message to the DU2, and the DU2 forwards the RRC release request message to the UE.

This RRC release request message may carry the configuration information of the MBS radio bearer. If the UE is not the first user under the DU, the CU2 may keep the UE in the RRC inactive status to receive the MBS data. The CU2 sends the RRC connection release request message to the UE, the RRC connection release request message is carried in a downlink RRC transmission message and sent to the DU2, and the DU2 sends the RRC transmission message to the UE. The RRC release request message carries the configuration information of the MBS radio bearer, and also carries the indication information to enable the UE to enter the inactive status. The UE, after receiving the RRC transmission message, may establish the MBS radio bearer, and enter the inactive status to receive the MBS service.

Through the above methods, it may reduce additional signaling overhead of multicast data transmission, increase access efficiency of access network resources and/or air interface resources, reduce transmission delay, and enable the UE to receive data of multicast services in an energy-saving manner.

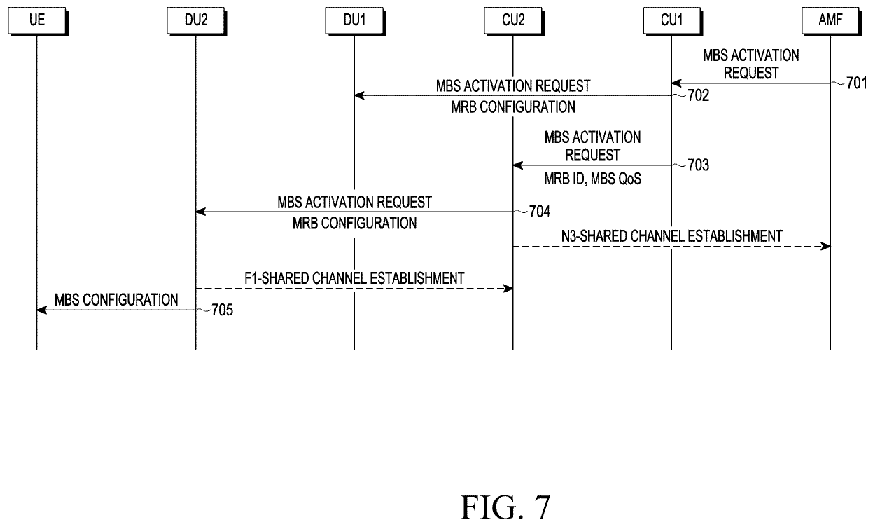

FIG. 7 shows a schematic diagram of a first example of a method for supporting multicast transmission according to an exemplary embodiment of the present disclosure. In this example, a UE in an inactive RRC status has joined a certain MBS group, information of unicast QoS flow associated with the MBS has been configured and activated, the core network initiates transmission of a MBS multicast service, and configuration of a MBS bearer is sent to the UE through a common channel. The specific activation process is shown in FIG. 7.

In step 701, an AMF sends a MBS activation request to the CU1.

A MB-SMF knows which NG-RANs have established the N3-shared channel, in this embodiment, the CU1 has established the N3-shared channel with a MB-UPF, and the MB-SMF sends the activation request message to the AMF node managing this CU1. For example, the MB-SMF sends an N2 transmission message to the AMF, which carries identification of the MBS and indication of the MBS activation request. The AMF sends the received MBS activation message to the CU1, and if the AMF may know an activation status of the MBS, the AMF sends the MBS activation request message to the CU, which carries the identification of the MBS and a service area of the MBS. Otherwise, the AMF sends a MBS status update message to the CU, which carries the identification of the MBS and the service area of the MBS.

In step 702, the CU1 sends the MBS activation request message to the DU1.

According to the service area of the MBS, the CU1 sends the MBS activation request message to the DU within this service area. The CU1 knows the identification of the MBS and the service area of the MBS by analyzing the contents in the message in the step 701, and the CU1 sends the MBS activation request message to the DU within this service area. Alternatively, the CU1 knows that the UE has joined the MBS service and that the UE is under a certain DU according to information of the MBS in the stored UE context, and the CU1 sends the MBS activation request message to the DU. The MBS activation request message carries the identification of the MBS and may also contain QoS configuration information of the MBS. The QoS information of the MBS has been stored on the CU1, so the QOS information of the MBS may be sent to the DU in this step. According to the QoS information of the MBS, the CU1 may also determine configuration information of the MRB, and the MBS activation request message may also carry configuration information of a MBS radio bearer. Alternatively, according to the QoS information of the MBS, the CU1 may also determine configuration information of a PDCP of the MBS radio bearer, the DU1 may determine configuration information of a RLC and a MAC of the MBS radio bearer, and the MBS activation request message in the step 702 may carry the configuration information of the PDCP of the MRB. The DU1 sends the configuration information of the MRB to the UE through the common channel of the air interface.

The present embodiment takes a CU-CP and a CU-UP on one entity as an example, and if the CU-CP and the CU-UP are in different entities, before this step, the CU1 finds the CU-UP transmitting the MBS and sends a message to the CU-UP, for example, sending the MBS activation request message or the MBS bearer establishment request message to the CU-UP, the sent message may carry the identification of the MBS and the QoS information of the MBS, and the CU-UP sends a response message to the CU1. This response message carries the identification of the MBS, and an uplink transmission layer address allocated for the MBS by the CU-UP, wherein the uplink transmission layer address contains an IP address and a channel number of the CU-UP, or the uplink transmission layer address contains the IP address of the CU-UP. The CU-UP allocates one uplink transmission layer address to the same MBS. If the CU-UP finds that this UE is the first user, under the CU-UP, to join the above MBS service, and the CU-UP enables to support a N3-shared channel, the CU-UP sends a N3-shared channel establishment request message to the CU1, which contains the identification of the MBS, and contains the downlink transmission layer address allocated by the CU-UP. The CU1 sends this N3-shared channel establishment request message to the AMF. The AMF forwards the N3-shared channel establishment request message to MB-SMF, and the MB-SMF forwards the N3-shared channel establishment request message to the MB-UPF to establish a N3-shared channel corresponding to this MBS.

In step 703, the CU1 sends the MBS activation request message to other CU2s.

The CU1 checks the context of the UE, when the UE is in a RRC inactive status, the UE may move within a RAN Notification Area (RNA) without notifying the CU, and therefore, the CU1 does not know in which cell the UE currently is, the CU1 sends the MBS activation request message to a DU within the RNA range and controlled by the CU1, and also to all other CU2s within the RNA range, and the other CU2s send the MBS activation request message to DUs controlled by itself and within the RNA range. In the present invention, the MBS activation request message contains information such as the identification of the MBS, quality requirements of the MBS, service area of the MBS, and so on.

If the CU2 has received the MBS activation request message from the core network and the MBS activation request message is for the same MBS multicast service, the CU2 may ignore the MBS activation request message received from a Xn interface.

The CU2 receives the MBS activation request message and if no UE in a RRC connection mode on the CU2 receives the MBS multicast service, the CU2 decides whether to enable the UE in a RRC inactive status enter the RRC connection mode or still receive the multicast service in the RRC inactive status. If the RRC connection mode will be entered, the CU2 may send a group paging request message to the UE, and since the group paging process sent by the CU has been described in the step 605, it is omitted here. If the CU2 decides that UE may keep in the RRC inactive status to receive the MBS service, the CU2 sends the MBS activation request message to the DU2 and proceeds to step 704.

In step 704, the CU2 sends the MBS activation request message to the DU2.

The CU2 receives the activation request message, and determines the configuration of the MBS radio bearer according to information in the activation request message, and the MBS activation request message in the step 704 may also carry the configuration information of the MBS radio bearer. Alternatively, according to the QoS information of the MBS, the CU2 may also determine the configuration information of the PDCP of the MBS radio bearer, and the DU may determine the configuration information of the RLC and MAC of the MBS radio bearer. The MBS activation request message in the step 704 may carry the configuration information of the PDCP of the MRB.

In step 705, the DU2 receives the MBS activation request message. The DU2 uses the air interface to send the configuration information of the MRB to UE through the common channel.

Through the above methods, it may reduce additional signaling overhead of multicast data transmission, increase access efficiency of access network resources and/or air interface resources, reduce transmission delay, and enable the UE to receive data of multicast services in an energy-saving manner.

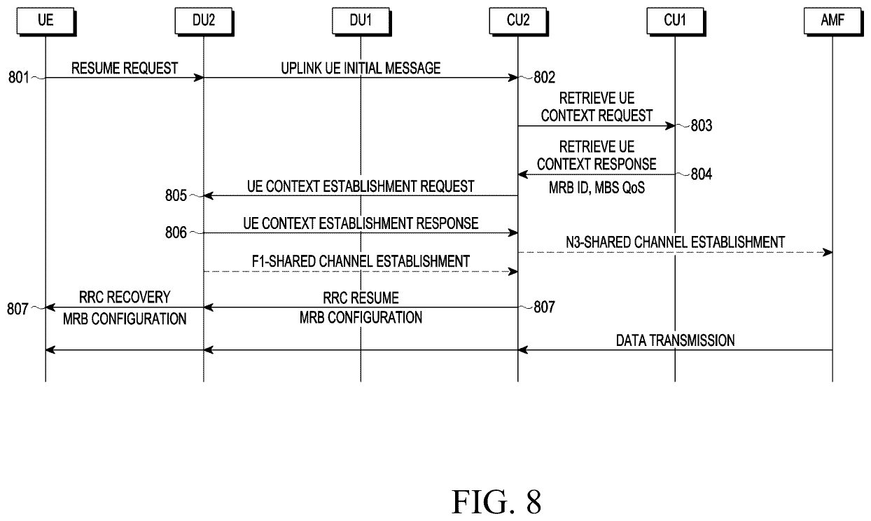

FIG. 8 is a schematic diagram showing a fourth example of a method for supporting multicast transmission according to an exemplary embodiment of the present disclosure. In this example, a UE in an RRC inactive status has joined to a certain MBS group, the cell under the CU1 receives a MBS service, and the UE moves to a new cell, which is under the control of the CU2. In the new cell, the UE needs to enter a connection mode to receive configuration information of a radio bearer of a MBS multicast service in the new cell. The specific activation process is shown in FIG. 8.

In step 801, the UE moves to the new cell, in the new cell, the UE does not obtain the configuration of the MBS radio bearer. The UE sends a resume request message to the CU2. This resume request message carries the identification of the UE (e.g., I-RNTI), a base station identification of a previous service, and a cell identification of the previous service. According to the present invention, this resume request message may also carry a resume reason, which is set for the MBS and indicates that the resume of RRC is requested due to the MBS, and in addition, this RRC resume request message may also carry the identification of the MBS.

In step 802, the DU2 sends an uplink UE initial message to the CU2, which carries the RRC resume request message.

In step 803, the CU2 sends an retrieve UE context request message to an old CU1. The CU2 receives the RRC resume request message and finds a last serving base station (or a last serving CU, called the old CU) of the UE according to information carried in the RRC resume request message. The CU2 sends the retrieve UE context request message to the old CU (i.e., the CU1), wherein this retrieve UE context request message carries an old base station identification, an old cell identification, and a user identification C-RNTI of the UE in the old cell. According to the method of the present invention, this retrieve UE context request message also carries indication information of the MBS, wherein this indication information is used to indicate that the context information of the UE is obtained due to the request of the MBS. Alternatively, this retrieve UE context request message also carries the identification of the MBS, and after receiving the retrieve UE context request message in this step, the current mechanism is that the old CU decides whether to send the context information of the UE to the new CU. According to the method of the present invention, the old CU must send the context information of the UE to the new CU according to the above indication information.

In step 804, the CU1 sends an retrieve UE context response message to the CU2.

This retrieve UE context response message contains the context information of the UE, and according to the method of the present invention, this retrieve UE context response message also contains the identification of the MBS, a QoS of the MBS, and a corresponding relation between a unicast QoS flow and a multicast QoS flow. This retrieve UE context response message also contains indication information of whether the MBS is activated, which is used to indicate whether the MBS is currently in an activated status or an inactive status.

The CU2 receives the retrieve UE context response message in the step 804, and if the retrieve UE context response message contains information such as the identification of the MBS and so on, the CU2 finds a CU-UP for transmitting the MBS, and sends a message to this CU-UP, for example, sends a MBS bearer establishment request message to the CU-UP, and the sent message may carry one or more of the identification of the MBS, the QoS information of the MBS, and the corresponding relation between the unicast QoS flow and the multicast QoS flow. For one MBS service, the CU-CP determines one CU-UP to transmit the MBS service.

The CU-UP sends the MBS bearer establishment response message to the CU. This MBS bearer establishment response message carries the identification of the MBS and an uplink transmission layer address for the MBS allocated by the CU-UP, wherein the uplink transmission layer address contains an IP address and a channel number of the CU-UP, or the uplink transmission layer address contains the IP address of the CU-UP. The CU-UP allocates one uplink transmission layer address to the same MBS.

If the CU-UP finds that this UE is the first user, under the CU-UP, to join the above MBS service, and the CU-UP enables to support a N3-shared channel, the CU-UP sends a N3-shared channel establishment request message to the CU, which contains the identification of the MBS and contains the downlink transmission layer address allocated by the CU-UP. The CU sends this N3-shared channel establishment request message to an AMF. The AMF forwards this N3-shared channel establishment request message to a MB-SMF, and the MB-SMF forwards this N3-shared channel establishment request message to a MB-UPF, to establish a N3-shared channel corresponding to this MBS.

In step 805, the CU2 sends a UE context establishment request message to the DU2. This UE context establishment request message contains configuration information of a bearer of the UE and configuration information of a SRB. According to the method of the present invention, this UE context establishment request message also contains the identification of MBS, the QoS information of MBS, and the uplink transmission layer address allocated by the CU-UP for the MBS. The uplink transmission layer address contains an IP address of the CU-UP and a channel identification allocated by the CU-UP. If this UE is the first MBS user on the DU, the CU may send the UE context establishment request message of the step 805, and this UE context establishment request message may also carry the RRC resume request message to enable the UE to enter a RRC connection mode.

In step 806, the DU2 sends a UE context establishment response message to the CU2. This UE context establishment response message carries information of the bearer which is successfully established.

If the DU finds that this UE is the first user, under this DU, to join the above MBS service, the DU sends an F1-shared channel establishment request message to the CU, which contains the identification of the MBS and contains the downlink transmission layer address allocated by the DU. Thus, a corresponding F1-shared channel is established for this MBS.

In step 807, the CU2 sends a RRC resume message to the DU2, and the DU2 forwards the RRC resume message to the UE.

The RRC resume message may carry the configuration information of the MBS radio bearer. If the UE is the first user, the CU2 sends RRC resume message to the UE to enable the UE to enter the RRC connection mode. If the UE is not the first user under the DU, the CU2 may keep the UE in the RRC inactive status to receive the MBS data. The CU2 sends a RRC connection release request message to the UE, which carries the configuration information of the MBS radio bearer, and also carries an indication information to enable the UE to enter the inactive status. The UE, after receiving the RRC release request message, may establish the MBS radio bearer, and enter the inactive status to receive the MBS service.

Through the above method, it may reduce additional signaling overhead of multicast data transmission, increase access efficiency of access network resources and/or air interface resources, reduce transmission delay, and enable the UE to receive data of multicast services in an energy-saving manner.

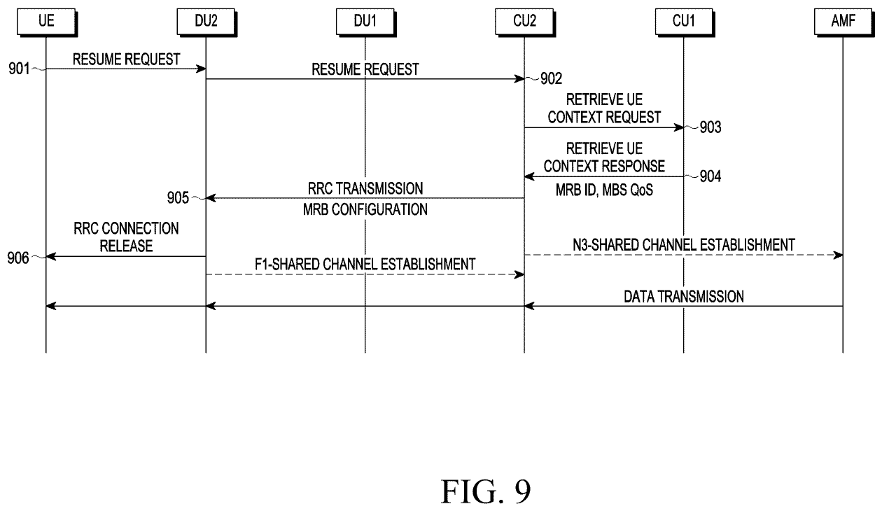

FIG. 9 is a schematic diagram showing a fifth example of a method for supporting multicast transmission according to an exemplary embodiment of the present disclosure. It is assumed that configuration information of a radio bearer of a multicast service is sent to a UE through a common channel. In this example, one UE in an RRC inactive status has joined to a certain MBS group, a cell under the CU1 receives a MBS service, and the UE moves to a new cell, wherein the new cell is under the control of the CU2. In the new cell, the UE does not receive configuration information of a radio bearer of a MBS multicast service transmitted by a common channel of an air interface. This is because there is no MBS user in the new cell, and this UE is the first user to receive MBS. The UE needs to perform the steps of this embodiment to obtain the configuration information of the MBS radio bearer. The specific activation process is shown in FIG. 9.

In step 901, the UE moves to the new cell, in the new cell, the UE does not obtain the configuration of the MBS radio bearer. The UE sends a resume request message to the CU2, which carries the identification of the UE (e.g., I-RNTI), a base station identification of a previous service, and a cell identification of the previous service. According to the present invention, this resume request message may also carry a resume reason, which is set for the MBS and is used to indicate that the resume of the RRC is requested due to the MBS and in addition, this RRC resume request message may also carry the identification of the MBS.

In step 902, the DU2 sends an uplink UE initial message to the CU2, which carries the RRC resume request message.

In step 903, the CU2 sends an retrieve UE context request message to an old CU1. The CU2 receives the RRC resume request message and finds a last serving base station (or a last serving CU, called the old CU) of the UE according to information carried in the RRC resume request message. The CU2 sends the retrieve UE context request message to the old CU (i.e., the CU1), which carries an old base station identification, an old cell identification, and a user identification C-RNTI of the UE in the old cell. According to the method of the present invention, this retrieve UE context request message also carries indication information of the MBS, wherein this indication information is used to indicate that the context information of the UE is obtained due to the request of the MBS. Alternatively, this retrieve UE context request message also carries the identification of the MBS, after receiving the retrieve UE context request message in this step, the current mechanism is that the old CU decides whether to send the context information of the UE to the new CU. According to the method of the present invention, the old CU must send the context information of the UE to the new CU according to the above indication information.

In step 904, the CU1 sends an retrieve UE context response message to the CU2.

This retrieve UE context response message contains the context information of the UE, and according to the method of the present invention, this retrieve UE context response message also contains the identification of the MBS, a QoS of the MBS, and a corresponding relation between a unicast QoS flow and a multicast QoS flow. This retrieve UE context response message also contains status information of the MBS, which contains indication information of whether it is activated and is used to indicate whether the MBS is currently in an activated status or an inactive status.

The CU2 receives the retrieve UE context response message in the step 904, and if the retrieve UE context response message contains information such as the identification of the MBS and so on, the CU2 finds a CU-UP for transmitting the MBS, and sends a message to this CU-UP, for example, sends a MBS bearer establishment request message to the CU-UP, wherein the sent message may carry one or more of the identification of the MBS, the QoS information of the MBS, and the corresponding relation between the unicast QoS flow and the multicast QoS flow. For one MBS service, the CU determines one CU-UP to transmit the MBS service.

The CU-UP sends the MBS bearer establishment response message to the CU. This MBS bearer establishment response message carries the identification of the MBS and an uplink transmission layer address for the MBS allocated by the CU-UP, wherein the uplink transmission layer address contains an IP address and a channel number of the CU-UP, or the uplink transmission layer address contains the IP address of the CU-UP. The CU-UP allocates one uplink transmission layer address to the same MBS.

If the CU-UP finds that this UE is the first user, under the CU-UP, to join the above MBS service, and the CU-UP enables to support a N3-shared channel, the CU-UP sends a N3-shared channel establishment request message to the CU, which contains the identification of the MBS and contains the downlink transmission layer address allocated by the CU-UP. The CU sends this N3-shared channel establishment request message to an AMF. The AMF forwards this N3-shared channel establishment request message to a MB-SMF, and the MB-SMF forwards this N3-shared channel establishment request message to a MB-UPF, to establish a N3-shared channel corresponding to this MBS.

In step 905, the CU2 sends a downlink RRC transmission message to the DU2.

The downlink RRC transmission message contains configuration information of a bearer of the UE, configuration information of a SRB and so on. According to the method of the present invention, the downlink RRC transmission message also contains identification of the MBS, contains QoS information of the MBS, and the uplink transmission layer address allocated for the MBS by CU-UP. The uplink transmission layer address contains an IP address of the CU-UP and a channel identification allocated by the CU-UP. The downlink RRC transmission message carries a RRC container, which contains a RRC connection release message. The RRC connection release message contains indication information that enables the UE to enter the inactive status, thereby enabling the UE to enter the inactive status to receive data of the MBS multicast service. The RRC connection release message may also contain the configuration information of the radio bearer of the MRB multicast service. The UE may configure the radio bearer of the response. Alternatively, the UE obtains the configuration information of the MBS radio bearer through the common channel of the cell.

According to the identification of the MBS and/or the uplink transmission layer address allocated for the MBS by the CU-UP, contained in the downlink RRC transmission message, the DU determines whether the UE is the first user, under the DU, to join the above MBS service, if so, the DU sends an F1-shared channel establishment request message to the CU, wherein the F1-shared channel establishment request message contains the identification of the MBS, and contains the downlink transmission layer address allocated by the DU, so as to establish a corresponding shared F1 channel for the MBS. In this way, the data may be sent from the MB-UPF to the DU, and then the DU sends the data to the UE.

In step 906, the DU2 sends an RRC connection release request message to the UE.

This RRC release request message may carry the configuration information of the MBS radio bearer. The CU2 may keep the UE in the RRC inactive status to receive the MBS data. The CU2 sends the RRC connection release request message to the UE, which carries the information of the MBS radio bearer, and also carries the indication information to enable the UE to enter the inactive status. The UE, after receiving the RRC release request message, may establish the MBS radio bearer, and enter the inactive status to receive the MBS service.

Through the above method, it may reduce additional signaling overhead of multicast data transmission, increase access efficiency of access network resources and/or air interface resources, reduce transmission delay, and enable the UE to receive data of multicast services in an energy-saving manner.

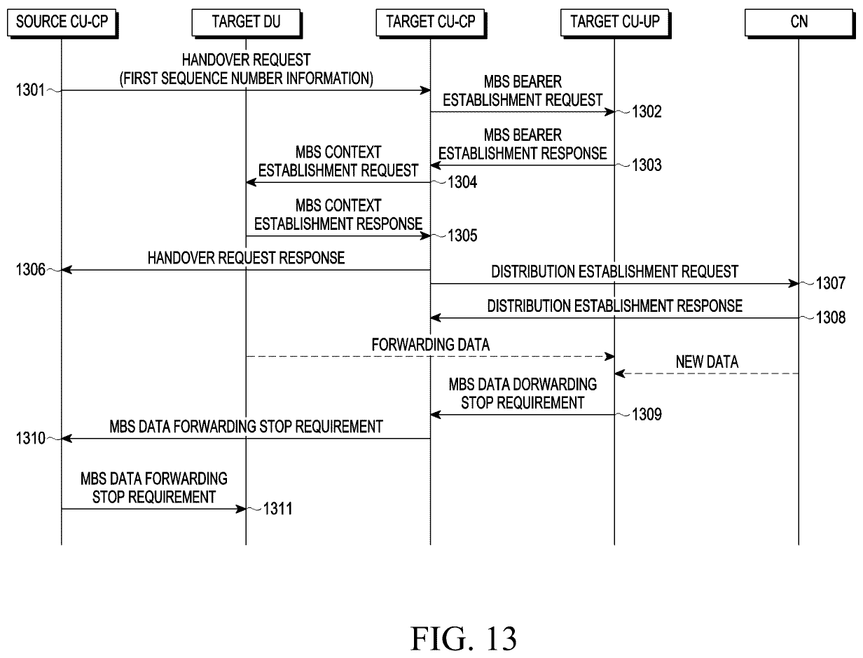

FIG. 13 is a schematic diagram showing a sixth embodiment of a method for supporting multicast transmission according to an exemplary embodiment of the present disclosure. In this example, the UE in a connection mode has joined in a certain MBS group, receives MBS service in a cell under a CU1, the UE moves to a new cell, and the new cell is under the control of a CU2. In the new cell, the UE needs to continue to receive data of the MBS. The specific movement process is shown in FIG. 13. Detailed descriptions of steps not related to the present invention are omitted here.

In step 1301, the source base station CU-CP initiates a handover request message to a target base station CU-CP.

The message carries a session identification of each requested PDU session, information about the QoS flow contained in the PDU session, DRB information, etc. Wherein, if the UE is receiving the MBS, the message further contains the identification of the MBS, a forwarding recommendation for the MBS service, or a forwarding recommendation for each radio bearer for the MBS. The message further contains the PDU session identification corresponding to the MBS, information of the QoS flow corresponding to the MBS, the mapping of the QoS flow to the MRB and/or the QoS flow to the DRB, configuration information of a MRB transmitting the MBS and/or a DRB transmitting the MBS, etc. The message may further contain first sequence number information, which may be a hyper frame number HFN number and a sequence number SN of the Packet Data Convergence Protocol (PDCP), or contain partial bits of the HFN number and partial bits of the PDCP SN number, or a bitstream formed by partial bits of the HFN and partial bits of the PDCP SN. This number is used to initialize a MRB reception window of the UE terminal. After the UE receives it, it can be used to set an initial value of the PDCP reception window. The HFN number and the PDCP number may be with respect to the QoS flow or the MRB. The first sequence number information may further be a SN number of a GTP-U, or be a PDCP SN, and the first sequence number information may be with respect to the QoS flow or the MRB.

Step 1302, the target CU-CP initiates an MBS bearer establishment request message to the target CU-UP.

The message contains the identification of the MBS, the forwarding recommendation for the MBS service, or the forwarding recommendation for each radio bearer for the MBS. The message further contains the PDU session identification corresponding to the MBS, the information of the QoS flow corresponding to the MBS, and the configuration information of the DRB transmitting the MBS and the like, and the message may further contain mapping information of the QoS flow to the MRB at the source base station for MBS. Whether the mapping of the QoS flow to MRB or mapping of QoS flow to DRB is the same as the mapping in the source base station is determined by the target CU-CP.

In step 1303, the target CU-UP initiates an MBS bearer establishment response message to the target CU-CP.

The message carries information of the successfully established PDU session, identification of the successfully established DRB, identification of the successfully established MBS, identification of the successfully established MRB, and transport layer address information of a NG-U shared tunnel corresponding to the MBS. The message further contains indication information that the target CU-UP determines that MBS data forwarding is required and may further contain information of the PDCP SN or the SN of GTP-U corresponding to the forwarded data.

In steps 1304, 1305, context of the UE is established between the target CU-CP and a DU, and this process is the same as the current process and is omitted here.

In step 1306, the target CU-CP sends a handover request acknowledge message to the source CU-CP. The message includes a target-to-source transparent transmitter. The target-to-source transparent transmitter contains RRC messages sent by the target base station to the UE. The RRC message contains the identification of the MRB and the second sequence number information. The second sequence number information is an initial value of the HFN and a reference value of the PDCP SN, and contains parts of the HFN number and parts of the PDCP SN number, that is, may contain partial bits of the HFN and partial bits of the PDCP SN, the two SNs may form a format of a bitstream, this number is used for the initialization of the MRB reception window at the UE terminal, and the target CU-CP generates the second sequence number information through the first sequence number information obtained from the source base station or the source CU-CP.

The message further contains the information of the successfully established PDU session. The information of the PDU session contains the identification of the PDU session, the identification of the successfully established DRB, the identification of the successfully established MBS, and the identification of the successfully established MRB. If the target base station is transmitting the MBS service in point-to-point transmission or point-to-multipoint transmission, the message further contains the indication information that the target base station determines that MBS data forwarding is required, and PDCP SN information and/or GTP-U SN corresponding to the forwarding data recommended by the target base station.

In step 1307, the target CU-CP sends a distribution establishment request message to a core network.

When the UE is the first user of the target base station that needs to receive the MBS, and the target base station has not received the MBS data from the core network, the target base station may request the transmission of the MBS data through the message in this step. The message in the step 1307 carries information of the MBS, such as the identification of the MBS, requests the core network to send the MBS data to the base station, and the message further contains the transport layer address information of the NG-U shared tunnel. The step 1307 in which the target CU-CP is sent may precede the step 1306.

In step 1308, the core network sends a distribution establishment response message to the target CU-CP.

The message includes the identification of the MBS, the information of the QoS flow of the MBS, and state information of the MBS, that is, information that whether the MBS is active or inactive. The NG-U shared tunnel is successfully established in this step, and the core network may send the MBS data to the base station through the tunnel.

In step 1309, the target CU-UP sends a data forwarding stop required message to the target CU-CP.

The target CU-UP receives the forwarding data sent from the source CU-UP, and also receives the data sent by the core network, from the core network. When the data sent by the core network and the forwarding data are the same data, it is not necessary for the source CU-UP to continue to forward data. Therefore, the target CU-UP sends the data forwarding stop required message to the target CU-CP, and initiates the process of data forwarding stop.

In step 1310, the target CU-CP sends the data forwarding stop required message to the source CU-CP.

In step 1311, the source CU-CP sends the data forwarding stop required message to the source CU-UP. The source CU-UP stops forwarding data to the target CU-UP.

This method can also be used for non-separated base stations. At this time, the CU-CP, the CU-UP and the DU are located in one physical entity, and signaling interaction between the CU-CP, the CU-UP and the DU may be omitted.

This method can also be used for the switching process based on an NG interface. At this time, the source base station or the source CU-CP initiates the switching process based on the NG interface. In the message of the switching process, the source base station sends a switching need message to the core network, and the core network sends a switching request message to the target base station or the target CU-CP. The switching need message or switching request message carries a source-to-target transparent container, and the first sequence number may be carried in the transparent container and sent from the source base station to the target base station or the target CU-CP. This method is similar to the method described in FIG. 13.

According to the method of the present invention, when the multicast transmission is switched, the continuity of the service can be guaranteed, the loss of data can be reduced, and the delay caused by the switching can be reduced.

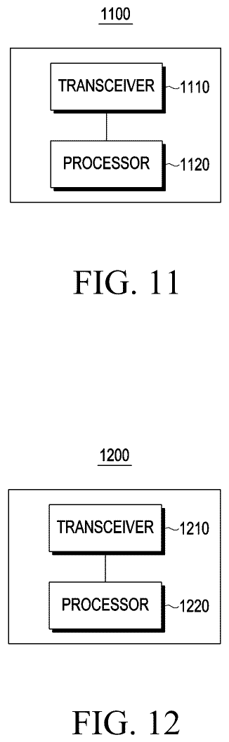

FIG. 11 is a block diagram showing a CU 1100 of a second base station according to an exemplary embodiment of the present disclosure, wherein the second base station may include the CU 1100 and at least one DU. Referring to FIG. 11, the CU 1100 may include a transceiver 1110 and a processor 1120, wherein the processor 1120 is coupled to the transceiver 1110 and configured to perform the method described above with reference to FIG. 5. With respect to details of the operations of the above method, please refer to the description in FIG. 5, which will not be repeated here.

FIG. 12 is a block diagram of a DU 1200 of a second base station according to an exemplary embodiment of the present disclosure, wherein the second base station may include a CU and at least one DU.

Referring to FIG. 12, the DU 1200 may include a transceiver 1210 and a processor 1220, wherein the processor 1230 is coupled to the transceiver 1210 and configured to perform the method described above with reference to FIG. 10. With respect to details of the operations of the above method, please refer to the description of FIG. 10, which will not be repeated here.

According to an embodiment of the present disclosure, a CU of a first base station may also be provided, wherein the first base station may include a CU and at least one DU. The CU may include a transceiver and a processor, wherein the processor is coupled to the transceiver and configured to perform the operations performed by the CU of the first base station described above (i.e. The CU1) with reference to any one of FIGS. 3A to 4B and 6 to 9. With respect to details of the above operations, please refer to the description of any one of FIGS. 3A to 4B and 6 to 9, which will not be repeated here.

According to the embodiment of the present disclosure, a User Equipment (UE) may also be provided, including: a transceiver; and a processor coupled to the transceiver and configured to perform the methods performed by the UE in the communication system as described above, in other words, configured to perform the operations performed by the UE described above with reference to any one of FIGS. 3A to 4B and 6 to 9. With respect to details of the above operations, please refer to the description of any one of FIGS. 3A to 4B and 6 to 9, which will not be repeated here.

According to an embodiment of the present disclosure, an electronic apparatus may also be provided, including: at least one processor; and at least one memory storing computer executable instructions, wherein the computer executable instructions, when being executed by the at least one processor, cause the at least one processor to perform any one of the above methods.

As an example, the electronic apparatus may be a PC computer, a tablet device, a personal digital assistant, a smart phone, or other devices capable of executing the above set of instructions. Here, the electronic apparatus does not have to be a single electronic apparatus and may also be any device or a collection of circuits that may execute the above instructions (or instruction sets) individually or jointly. The electronic apparatus may also be a part of an integrated control system or a system manager, or may be configured as a portable electronic apparatus interconnected by an interface with a local or remote (e.g., via wireless transmission).

In the electronic apparatus, the processor may include a central processing unit (CPU), a graphics processing unit (GPU), a programmable logic device, a dedicated processor system, a microcontroller, or a microprocessor. As an example and not limitation, the processor may also include an analog processor, a digital processor, a microprocessor, a multi-core processor, a processor array, a network processor, and the like.

The processor may execute instructions or codes stored in the memory, where the memory may also store data. Instructions and data may also be transmitted and received through a network via a network interface device, wherein the network interface device may use any known transmission protocol.

The memory may be integrated with the processor as a whole, for example, RAM or a flash memory is arranged in an integrated circuit microprocessor or the like. In addition, the memory may include an independent device, such as an external disk drive, a storage array, or other storage device that may be used by any database system. The memory and the processor may be operatively coupled, or may communicate with each other, for example, through an I/O port, a network connection, or the like, so that the processor may read files stored in the memory.

In addition, the electronic apparatus may also include a video display (such as a liquid crystal display) and a user interaction interface (such as a keyboard, a mouse, a touch input device, etc.). All components of the electronic apparatus may be connected to each other via a bus and/or a network.

According to an embodiment of the present disclosure, there may also be provided a computer-readable storage medium storing instructions, wherein the instructions, when executed by at least one processor, cause the at least one processor to execute any of the image processing methods according to the exemplary embodiment of the present disclosure. Examples of the computer-readable storage medium here include: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, Hard Disk Drive (HDD), Solid State Drive (SSD), card storage (such as multimedia card, secure digital (SD) card or extremely fast digital (XD) card), magnetic tape, floppy disk, magneto-optical data storage device, optical data storage device, hard disk, solid state disk and any other devices which are configured to store computer programs and any associated data, data files, and data structures in a non-transitory manner, and provide the computer programs and any associated data, data files, and data structures to the processor or the computer, so that the processor or the computer may execute the computer programs. The instructions and the computer programs in the above computer-readable storage mediums may run in an environment deployed in computer equipment such as a client, a host, an agent device, a server, etc. In addition, in one example, the computer programs and any associated data, data files and data structures are distributed on networked computer systems, so that computer programs and any associated data, data files, and data structures are stored, accessed, and executed in a distributed manner through one or more processors or computers.

Those skilled in the art will easily think of other embodiments of the present disclosure after considering the specification and practicing the invention disclosed herein. The present application is intended to cover any variations, uses, or adaptive changes of the present disclosure. These variations, uses, or adaptive changes follow the general principles of the present disclosure and include common knowledge or conventional technical means in the technical field that are not disclosed in the present disclosure. The specification and the embodiments are only to be regarded as exemplary, and the true scope and spirit of the present disclosure are defined by the claims.

1.-15. (canceled)

16. A method for communication by a user equipment (UE) in a wireless communication system, the method comprising:
transmitting, to a base station, a radio resource control (RRC) resume request message based on the UE being not available configuration related to multicast service; and
receiving, from the base station, an RRC release message comprising the configuration related to the multicast service, based on receiving the RRC resume request message.

17. The method of claim 16, wherein the RRC release message further comprises indication of configuration of an RRC inactive state of the UE.

18. The method of claim 16, wherein the RRC resume request message is transmitted in an RRC inactive state of the UE.

19. The method of claim 16, wherein the configuration related to the multicast service includes configuration information related to a radio bearer for the multicast service.

20. The method of claim 16, further comprising:
configuring a radio bearer for the multicast service based on the configuration.

21. A method for communication by a base station in a wireless communication system, the method comprising:
receiving, from a user equipment (UE), a radio resource control (RRC) resume request message based on the UE being not available configuration related to multicast service; and
transmitting, to the UE, an RRC release message comprising the configuration related to the multicast service, based on receiving the RRC resume request message.

22. The method of claim 21, wherein the RRC release message further comprises indication of configuration of an RRC inactive state of the UE.

23. The method of claim 21, wherein the RRC resume request message is transmitted in an RRC inactive state of the UE.

24. The method of claim 21, wherein the configuration related to the multicast service includes configuration information related to a radio bearer for the multicast service.

25. A user equipment (UE) in a wireless communication system, the UE comprising:
a transceiver; and
at least one processor coupled to the transceiver, wherein the at least one processor is configured to:
transmit, to a base station, a radio resource control (RRC) resume request message based on the UE being not available configuration related to multicast service; and
receive, from the base station, an RRC release message comprising the configuration related to the multicast service, based on receiving the RRC resume request message.

26. The UE of claim 25, wherein the RRC release message further comprises indication of configuration of an RRC inactive state of the UE.

27. The UE of claim 25, wherein the RRC resume request message is transmitted in an RRC inactive state of the UE.

28. The UE of claim 25, wherein the configuration related to the multicast service includes configuration information related to a radio bearer for the multicast service.

29. The UE of claim 25, wherein the at least one processor is further configured to:
configure a radio bearer for the multicast service based on the configuration.
